(19) United States
(12) Patent Application Publication
(10) Pub. No.: US 2026/0005777 A1
(43) Pub. Date: Jan. 1, 2026

(54) EFFECTIVE ISOTROPIC RADIATED POWER MASK CONFORMANCE TESTING PROCEDURE FOR A NETWORK NODE USING A LINK ESTABLISHMENT NODE

(71) Applicant: QUALCOMM Incorporated, San Diego, CA (US)

(72) Inventors: Vasanthan RAGHAVAN, West Windsor Township, NJ (US); Mustafa EMARA, Munich (DE); Marco PAPALEO, Bologna (IT)

(21) Appl. No.: 18/755,256

(22) Filed: Jun. 26, 2024

(51) Int. Cl. H04B 17/13; H04B 17/10; H04W 24/10

(52) U.S. Cl. CPC H04B 17/13; H04B 17/103; H04W 24/10

(57) ABSTRACT

Various aspects of the present disclosure generally relate to wireless communication. In some aspects, a link establishment node (LEN) may transmit, using a first polarization, one or more reference signals that are configured for an effective isotropic radiated power (EIRP) conformance testing procedure for a network node. The LEN may transmit, based at least in part on expiration of a beam selection timer, a beam lock command that is directed to the network node. The LEN may transmit, based at least in part on transmitting the beam lock command, an indication of an uplink grant that is configured for the EIRP conformance testing procedure and is assigned to the network node. Numerous other aspects are described.

### FIELD OF THE DISCLOSURE

Aspects of the present disclosure generally relate to wireless communication and specifically relate to techniques, apparatuses, and methods for conformance testing of an effective isotropic radiated power mask (e.g., provided by regulatory authorities) using a link establishment node.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a link establishment node (LEN). The method may include transmitting, using a first polarization, one or more reference signals that are configured for an effective isotropic radiated power (EIRP) mask conformance testing procedure for a network node. The method may include transmitting, based at least in part on expiration of a beam selection timer, a beam lock command that is directed to the network node. The method may include transmitting, based at least in part on transmitting the beam lock command, an indication of an uplink grant that is configured for the EIRP mask conformance testing procedure and is assigned to the network node.

Some aspects described herein relate to a method of wireless communication performed by a network node. The method may include receiving one or more reference signals that have a first polarization, the one or more reference signals being configured for an EIRP mask conformance testing procedure for the network node. The method may include receiving a beam lock command that indicates to select a locked beam pair. The method may include receiving an uplink grant that is configured for the EIRP mask conformance testing procedure and is assigned to the network node. The method may include transmitting one or more transmissions using the locked beam pair.

Some aspects described herein relate to a method of wireless communication performed by a test equipment. The method may include receiving an indication to initiate a measurement cycle that is at least part of an EIRP mask conformance testing procedure for a network node, generating, at a first orientation of the test equipment, first one or more measurement metrics. The method may include reconfiguring the test equipment to at least a second orientation. The method may include generating, at the second orientation, second one or more measurement metrics.

Some aspects described herein relate to an apparatus for wireless communication at an LEN. The apparatus may include one or more memories and one or more processors coupled to the one or more memories. The one or more processors may be configured, individually or collectively, to transmit, using a first polarization, one or more reference signals that are configured for an EIRP mask conformance testing procedure for a network node. The one or more processors may be configured to transmit, based at least in part on expiration of a beam selection timer, a beam lock command that is directed to the network node. The one or more processors may be configured to transmit, based at least in part on transmitting the beam lock command, an indication of an uplink grant that is configured for the EIRP mask conformance testing procedure and is assigned to the network node.

Some aspects described herein relate to an apparatus for wireless communication at a network node. The apparatus may include one or more memories and one or more processors coupled to the one or more memories. The one or more processors may be configured, individually or collectively, to receive one or more reference signals that have a first polarization, the one or more reference signals being configured for an EIRP mask conformance testing procedure for the network node. The one or more processors may be configured, individually or collectively, to receive a beam lock command that indicates to select a locked beam pair. The one or more processors may be configured to receive an uplink grant that is configured for the EIRP mask conformance testing procedure and is assigned to the network node. The one or more processors may be configured, individually or collectively, to transmit one or more transmissions using the locked beam pair.

Some aspects described herein relate to an apparatus for wireless communication at a test equipment. The apparatus may include one or more memories and one or more processors coupled to the one or more memories. The one or more processors may be configured, individually or collectively, to receive an indication to initiate a measurement cycle that is at least part of an EIRP mask conformance testing procedure for a network node, generate, at a first orientation of the test equipment, first one or more measurement metrics. The one or more processors may be configured, individually or collectively, to reconfigure the test equipment to at least a second orientation. The one or more processors may be configured, individually or collectively, to generate, at the second orientation, second one or more measurement metrics.

Some aspects described herein relate to a non-transitory computer-readable medium that stores a set of instructions for wireless communication by an LEN. The set of instructions, when executed by one or more processors of the LEN, may cause the LEN to transmit, using a first polarization, one or more reference signals that are configured for an EIRP mask conformance testing procedure for a network node. The set of instructions, when executed by one or more processors of the LEN, may cause the LEN to transmit, based at least in part on expiration of a beam selection timer, a beam lock command that is directed to the network node. The set of instructions, when executed by one or more processors of the LEN, may cause the LEN to transmit, based at least in part on transmitting the beam lock command, an indication of an uplink grant that is configured for the EIRP mask conformance testing procedure and is assigned to the network node.

Some aspects described herein relate to a non-transitory computer-readable medium that stores a set of instructions for wireless communication by a network node. The set of instructions, when executed by one or more processors of the network node, may cause the network node to receive one or more reference signals that have a first polarization, the one or more reference signals being configured for an EIRP mask conformance testing procedure for the network node. The set of instructions, when executed by one or more processors of the network node, may cause the network node to receive a beam lock command that indicates to select a locked beam pair. The set of instructions, when executed by one or more processors of the network node, may cause the network node to receive an uplink grant that is configured for the EIRP mask conformance testing procedure and is assigned to the network node. The set of instructions, when executed by one or more processors of the network node, may cause the network node to transmit one or more transmissions using the locked beam pair.

Some aspects described herein relate to a non-transitory computer-readable medium that stores a set of instructions for wireless communication by a test equipment. The set of instructions, when executed by one or more processors of the test equipment, may cause the test equipment to receive an indication to initiate a measurement cycle that is at least part of an EIRP mask conformance testing procedure for a network node, generate, at a first orientation of the test equipment, first one or more measurement metrics. The set of instructions, when executed by one or more processors of the test equipment, may cause the test equipment to reconfigure the test equipment to at least a second orientation. The set of instructions, when executed by one or more processors of the test equipment, may cause the test equipment to generate, at the second orientation, second one or more measurement metrics.

Some aspects described herein relate to an apparatus for wireless communication. The apparatus may include means for transmitting, using a first polarization, one or more reference signals that are configured for an EIRP mask conformance testing procedure for a network node. The apparatus may include means for transmitting, based at least in part on expiration of a beam selection timer, a beam lock command that is directed to the network node. The apparatus may include means for transmitting, based at least in part on transmitting the beam lock command, an indication of an uplink grant that is configured for the EIRP mask conformance testing procedure and is assigned to the network node.

Some aspects described herein relate to an apparatus for wireless communication. The apparatus may include means for receiving one or more reference signals that have a first polarization, the one or more reference signals being configured for an EIRP mask conformance testing procedure for the network node. The apparatus may include means for receiving a beam lock command that indicates to select a locked beam pair. The apparatus may include means for receiving an uplink grant that is configured for the EIRP mask conformance testing procedure and is assigned to the network node. The apparatus may include means for transmitting one or more transmissions using the locked beam pair.

Some aspects described herein relate to an apparatus for wireless communication. The apparatus may include means for receiving an indication to initiate a measurement cycle that is at least part of an EIRP mask conformance testing procedure for a network node, means for generating, at a first orientation of the test equipment, first one or more measurement metrics. The apparatus may include means for reconfiguring the test equipment to at least a second orientation. The apparatus may include means for generating, at the second orientation, second one or more measurement metrics.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of effective isotropic radiated power, in accordance with the present disclosure.

FIG. 5 is a diagram illustrating an example of a conformance test environment, in accordance with the present disclosure.

FIG. 6 is a diagram illustrating an example of a wireless communication process between a network node, a link establishment node (LEN), and test equipment, in accordance with the present disclosure.

FIG. 7 is a diagram illustrating an example of a wireless communication process between the network node, the LEN, and the test equipment described with regard to FIG. 6, in accordance with the present disclosure.

FIG. 8 is a diagram illustrating an example process performed, for example, at an LEN or an apparatus of an LEN, in accordance with the present disclosure.

FIG. 9 is a diagram illustrating an example process performed, for example, at a network node or an apparatus of a network node, in accordance with the present disclosure.

FIG. 10 is a diagram illustrating an example process performed, for example, at a test equipment or an apparatus of a test equipment, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. In some aspects, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

To ensure that the operation of a wireless network is reliable and/or safe, a regulating body may specify an operating condition for operating in a wireless network (e.g., a regulatory limitation). One such example is an effective isotropic radiated power (EIRP) operating condition. EIRP is a measurement metric that indicates a total radiated power of an antenna system when transmitted by a hypothetical isotropic antenna system that transmits an electromagnetic wave uniformly in all directions. Using a hypothetical isotropic antenna system to characterize a total radiated power provides a baseline and/or reference for analyzing antenna gain, a measure of coverage, and/or a measure of interference management. In some aspects, the regulating body may specify, as an operating condition, that a wireless communication device should comply with an EIRP mask to mitigate interference and/or to manage coexistence of multiple wireless communication devices operating within the wireless network. An EIRP mask may specify respective worst-case thresholds and/or respective average EIRP thresholds for different elevation directions. That is, the EIRP mask may specify an EIRP threshold that indicates how much transmit power a wireless communication device is allowed to transmit in a certain elevation direction so as to mitigate interference to potential victim nodes along those directions.

“Conformance testing,” which may also be referred to as compliance testing, denotes a process and/or procedure that may be used to verify compliance with an operating condition, such as an EIRP mask operating condition that is specified by a regulatory body. In some aspects, a network node manufacturer and/or a user equipment (UE) manufacturer may perform conformance testing to validate that a network node and/or a UE acting as an aggressor wireless communication device, respectively, is compliant with an EIRP threshold and/or an EIRP mask. As radio technologies advance to using higher frequencies, a regulatory body may specify an updated EIRP mask that is based at least in part on the higher frequencies. Updates to an EIRP mask may result in updates to a conformance testing procedure in order to verify compliance with the updated EIRP mask.

As one example, a conformance test may include a wireless communication device (e.g., a UE and/or a network node) transmitting K beams for M elevation angles and N azimuth angles, where K, M, and N are integers, and test equipment generating a measurement metric for each sampling point (e.g., each unique combination of a beam, an elevation angle, and an azimuth angle). The process may repeat, such that the wireless communication device transmits a second set of KMN beams using a second polarization. Alternatively, or additionally, the wireless communication device may move from the first location to a second location and repeat transmitting the first set of KMN beams using the first polarization and the second set of KMN beams using the second polarization. The test equipment may generate a respective set of measurement metrics for each wireless communication device location and/or polarization. Some factors may increase the number of transmissions and/or measurement metrics, such as the number of beams (e.g., K) increasing as an antenna array size increases and/or the number of elevation angles (e.g., M) and/or the number of azimuth angles (e.g., N) increasing to obtain a finer resolution and/or increase a precision. The increases in the number of beams, the number of elevation angles, the number of azimuth angles, and/or the number of locations may extend a duration of a compliance test, increase resource consumption (e.g., air interface resources, personnel resources, and/or power resources), increase a complexity of analyzing the measurement results, and/or increase a complexity of configuring the compliance test.

Alternatively, or additionally, difficulties arise in selecting which elevation angles and/or which azimuth angles to use as part of the K beams, the M elevation angles, and/or the N azimuth angles. To illustrate, the wireless communication device under test may transmit the K beams using test beamforming vectors, may rotate between M elevation angles, and may rotate between N azimuth angles to simulate various potential operating orientations, but a practical operating orientation (e.g., a particular beam, a particular elevation angle, and/or a particular azimuth angle used in a real-world operating scenario) may be unclear, resulting in uncertainty between EIRP mask conformance testing results and compliance with an operating condition in a practical and/or real-world deployment. In some aspects, the test beamforming vectors may vary from beamforming codebooks utilized in a real-world deployment scenario, which may also lead to uncertainty between EIRP mask conformance testing results and compliance with an operating condition in a real-world deployment. The uncertainty may result in failure to comply with an EIRP mask, resulting in signal degradation (e.g., increased interference), increased recovery errors, and/or decreased data throughput in a wireless network.

Various aspects relate generally to EIRP mask conformance testing for a network node using a link establishment node (LEN). Some aspects more specifically relate to an LEN and test equipment changing orientations to test transmission by the network node. In some aspects, an LEN may transmit, using a first polarization, one or more reference signals that are configured for an EIRP mask conformance testing procedure for a network node. Based at least in part on expiration of a beam selection timer, the LEN may transmit a beam lock command that is directed to the network node. The beam selection timer may be based at least in part on a duration used by the network node to select a beam pair. In some aspects, the network node may select the beam pair using one or more measurement metrics that are generated using the reference signal(s). Based at least in part on transmitting the beam lock command, the LEN may transmit an indication of an uplink grant that is configured for the EIRP mask conformance testing procedure and is assigned to the network node. To illustrate, the uplink grant may include a number of resources that are based at least in part on a number of transmissions generated by the network node and/or measurement metrics generated by a test equipment. The LEN may repeat transmitting the reference signal(s) as described above using a second polarization, may repeat transmitting the commands, may repeat transmitting an uplink grant, and/or may repeat an entirety of the process based at least in part on changing an orientation, as described below. Repeating one or more aspects of the process may include some variations, such as transmitting a different uplink grant configuration and/or transmitting a different reference signal.

In some aspects, a network node may receive one or more reference signals that have a first polarization, and the one or more reference signals may be configured for an EIRP conformance testing procedure for the network node, such an EIRP mask conformance testing procedure. To illustrate, the one or more reference signals may use a variety of beams that are based at least in part on a portion of a sphere being tested in the EIRP mask conformance testing procedure. The network node may receive a beam lock command that indicates to select a locked beam pair, and the network node may select the locked beam pair using one or more measurement metrics generated using the reference signal(s). Based at least in part on receiving the beam lock command and/or selecting the locked beam pair, the network node may receive an uplink grant that is configured for the EIRP conformance testing procedure and is assigned to the network node. In some aspects, the network node may transmit one or more transmissions using the locked beam pair. As one example, the network node may transmit one or more reference signals using the uplink grant and the locked beam pair.

In some aspects, a test equipment may receive an indication to initiate a measurement cycle that is at least part of an EIRP mask conformance testing procedure for a network node. As at least part of the measurement cycle, the test equipment may operate at a first orientation and may generate first one or more measurement metrics, such as power level measurement metrics and/or interference level measurement metrics. The first orientation of the test equipment may include an elevation angle, an azimuth angle, an axis of rotation, and/or an angle of rotation around the axis of rotation. Alternatively, or additionally, the first orientation may include a location of the test equipment. In some aspects, the test equipment may reconfigure to at least a second orientation, and may generate, at the second orientation, second one or more measurement metrics. The first measurement metric(s) and the second measurement metric(s) may be used to verify compliance (or not) with an operating condition, such as an operating condition that specifies an EIRP mask.

Particular aspects of the subject matter described in this disclosure can be implemented to realize one or more of the following potential advantages. In some examples, by using an LEN, the described techniques can be used to enable EIRP mask conformance testing that verifies whether a network node is compliant with an EIRP mask operating condition, such as an EIRP mask specified by a regulatory body. More particularly, the LEN may function as a UE (e.g., a virtual UE that models a UE in a practical deployment scenario for the network node) that establishes a connection with the network node, and the network node may communicate with the LEN using one or more beams that are formed using a beamforming codebook. In some aspects, the beamforming codebook may be used by the network node in a practical and/or real-world deployment scenario in which the network node provides service to one or more UEs. That is, the beamforming codebook may include beam weights that may be used by the network node to communicate in a wireless network (e.g., where the network node is a potential aggressor node), resulting in EIRP mask compliance testing results that align more with a real-world deployment scenario, relative to an EIRP mask conformance testing procedure that uses beams that are configured via test beamforming vectors that are not used by the network node in the wireless network and/or real-world deployment. EIRP mask compliance testing results that align with a real-world deployment scenario may reduce an uncertainty in the results, leading to compliance with an EIRP mask in the real-world deployment, reduced signal degradation (e.g., reduced interference), reduced recovery errors, and/or increased data throughput in a wireless network.

As part of the EIRP mask conformance testing procedure, the LEN and/or the test equipment may rotate around respective axes in a manner that replicates potential locations of UEs in communication with the network node and/or victim UEs. That is, the LEN and/or the test equipment may be positioned at the locations and/or orientations of the UEs and/or victim UEs, which provides more certainty between an EIRP mask conformance testing result and real-world deployment, relative to an EIRP mask conformance testing result that is based at least in part on rotating a wireless communication device under test without certainty as to which orientation simulates a real-world deployment. Alternatively, or additionally, the ability to position the LEN and/or test equipment at the locations and/or orientations of the UEs and/or victim UEs may lead to using fewer beams, fewer elevation angles, and/or fewer azimuth angles, relative to rotating the wireless communication device under test, resulting in a shorter duration for an EIRP mask conformance testing procedure, decreased complexity of analyzing the measurement results, and/or decreased complexity of configuring the compliance test times.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

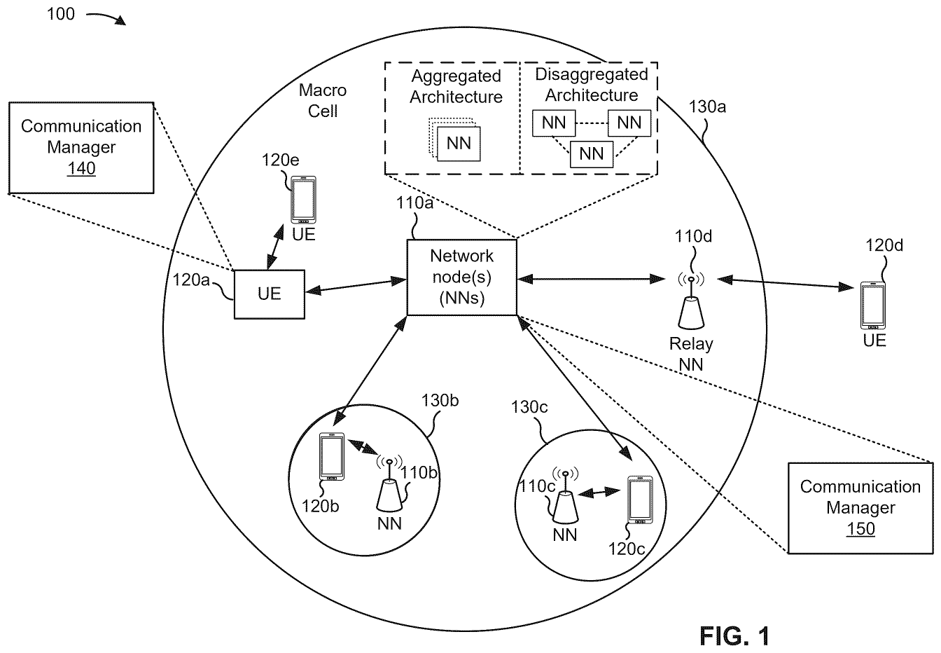

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

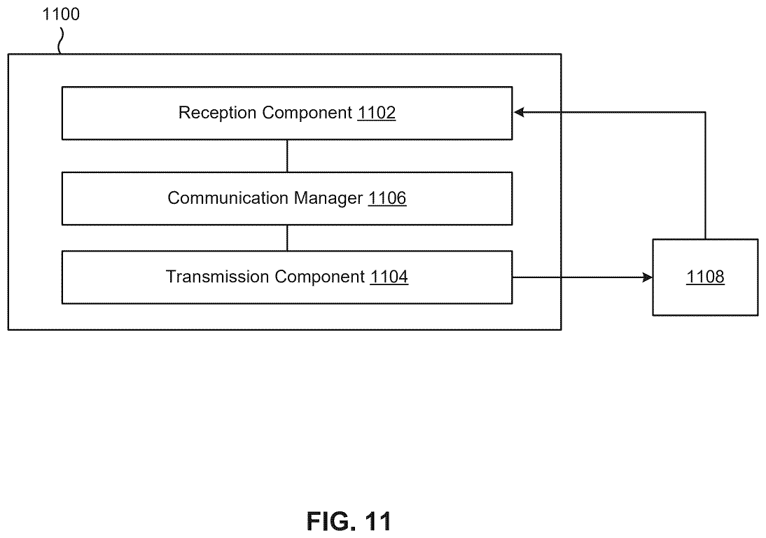

In some aspects, an LEN (e.g., a UE 120a and/or an apparatus 1100 as described below with regard to FIG. 11) may include a communication manager 140. As described in more detail elsewhere herein, and based at least in part on operating in an LEN, the communication manager 140 may transmit, using a first polarization, one or more reference signals that are configured for an EIRP conformance testing procedure (e.g., an EIRP mask conformance testing procedure) for a network node; transmit, based at least in part on expiration of a beam selection timer, a beam lock command that is directed to the network node; and transmit, based at least in part on transmitting the beam lock command, an indication of an uplink grant that is configured for the EIRP conformance testing procedure and is assigned to the network node. Additionally, or alternatively, the communication manager 140 may perform one or more other operations described herein.

In some aspects, a network node (e.g., a network node 110) may include a communication manager 150. As described in more detail elsewhere herein, the communication manager 150 may receive one or more reference signals that have a first polarization, the one or more reference signals being configured for an EIRP conformance testing procedure for the network node (e.g., an EIRP mask conformance testing procedure); receive a beam lock command that indicates to select a locked beam pair; receive an uplink grant that is configured for the EIRP conformance testing procedure and is assigned to the network node; and transmit one or more transmissions using the locked beam pair. Additionally, or alternatively, the communication manager 150 may perform one or more other operations described herein.

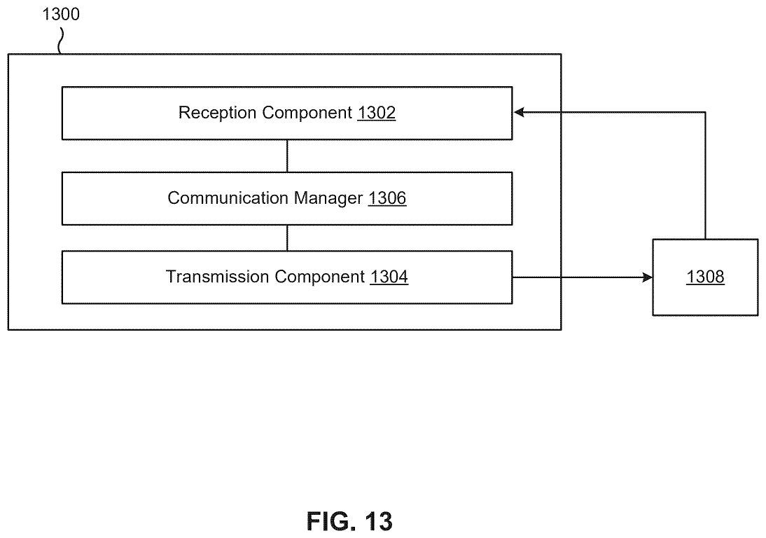

In some aspects, a test equipment (e.g., a UE 120a and/or an apparatus 1300 as described below with regard to FIG. 13) may include a communication manager 140. As described in more detail elsewhere herein, the communication manager 140, based at least in part on operating in the test equipment, may receive an indication to initiate a measurement cycle that is at least part of an EIRP conformance testing procedure for a network node generate, at a first orientation of the test equipment, first one or more measurement metrics; reconfigure the test equipment to at least a second orientation; and generate, at the second orientation, second one or more measurement metrics. Additionally, or alternatively, the communication manager 140 may perform one or more other operations described herein.

As indicated above, FIG. 1 is provided as an example. Other examples may differ from what is described with regard to FIG. 1.

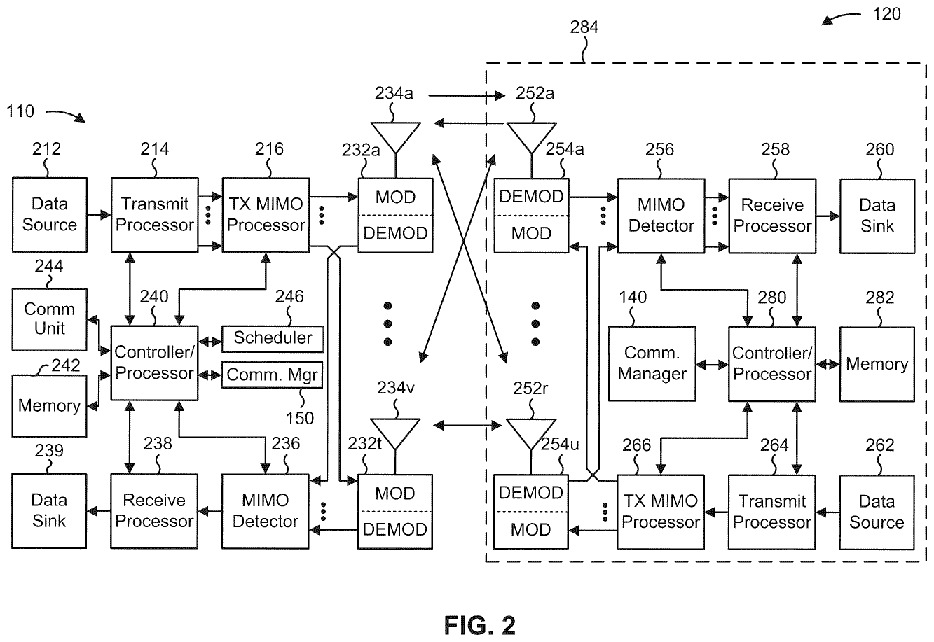

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

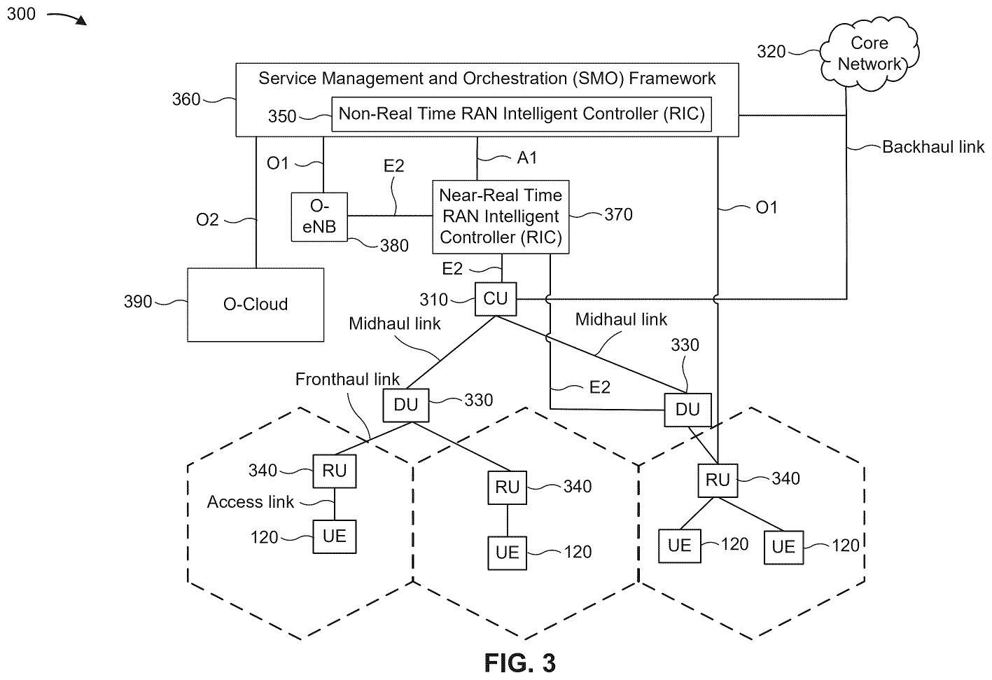

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

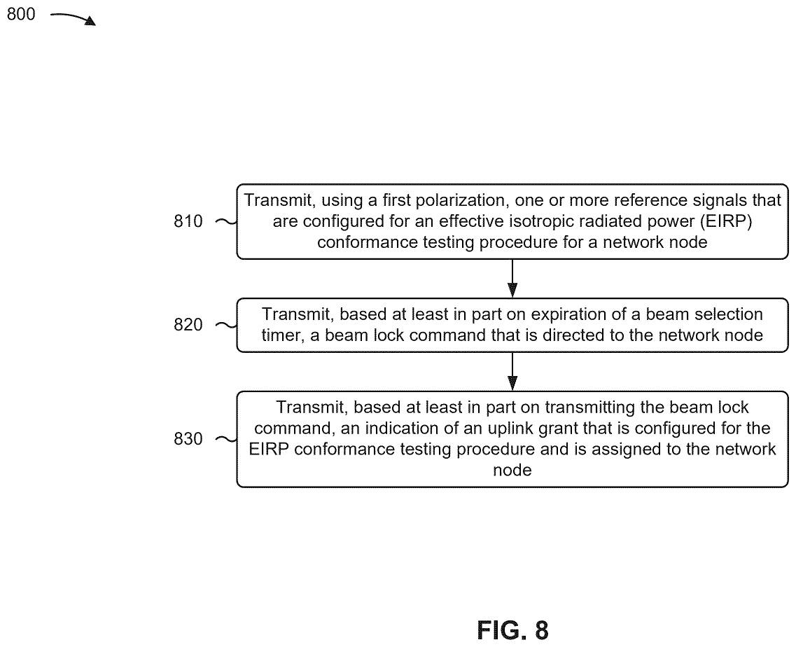

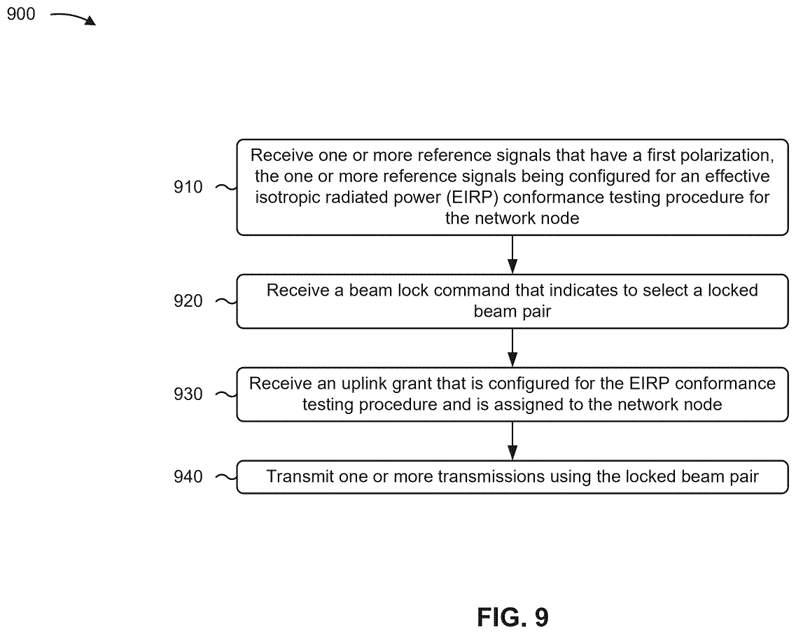

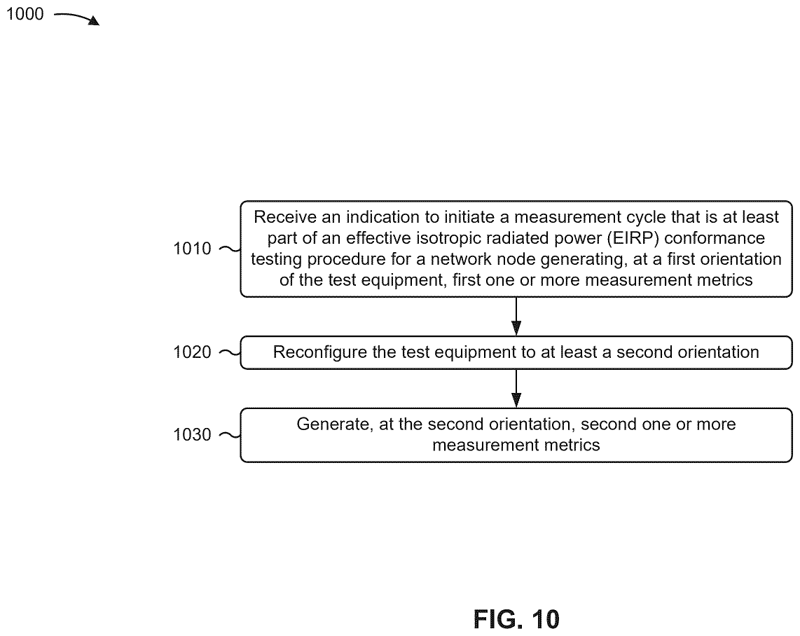

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with conformance testing using a link establishment node, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, process 1000 of FIG. 10, or other processes as described herein (alone or in conjunction with one or more other processors). In some aspects, the LEN described herein is the UE 120, is included in the UE 120, or includes one or more components of the UE 120 shown in FIG. 2. Alternatively, or additionally, in some aspects, the test equipment described herein is the UE 120, is included in the UE 120, or includes one or more components of the UE 120 shown in FIG. 2. The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, an LEN (e.g., an apparatus 1100) includes means for transmitting, using a first polarization, one or more reference signals that are configured for an EIRP mask conformance testing procedure for a network node; means for transmitting, based at least in part on expiration of a beam selection timer, a beam lock command that is directed to the network node; and/or means for transmitting, based at least in part on transmitting the beam lock command, an indication of an uplink grant that is configured for the EIRP mask conformance testing procedure and is assigned to the network node. In some aspects, the means for the LEN to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., a network node 110) includes means for receiving one or more reference signals that have a first polarization, the one or more reference signals being configured for an EIRP mask conformance testing procedure for the network node; means for receiving a beam lock command that indicates to select a locked beam pair; means for receiving an uplink grant that is configured for the EIRP mask conformance testing procedure and is assigned to the network node; and/or means for transmitting one or more transmissions using the locked beam pair. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

In some aspects, a test equipment (e.g., an apparatus 1300) includes means for receiving an indication to initiate a measurement cycle that is at least part of an EIRP mask conformance testing procedure for a network node means for generating, at a first orientation of the test equipment, first one or more measurement metrics; means for reconfiguring the test equipment to at least a second orientation; and/or means for generating, at the second orientation, second one or more measurement metrics. In some aspects, the means for the test equipment to perform operations described herein may include, for example, one or more of communication manager 140, antenna 252, modem 254, MIMO detector 256, receive processor 258, transmit processor 264, TX MIMO processor 266, controller/processor 280, or memory 282.

As indicated above, FIG. 3 is provided as an example. Other examples may differ from what is described with regard to FIG. 3.

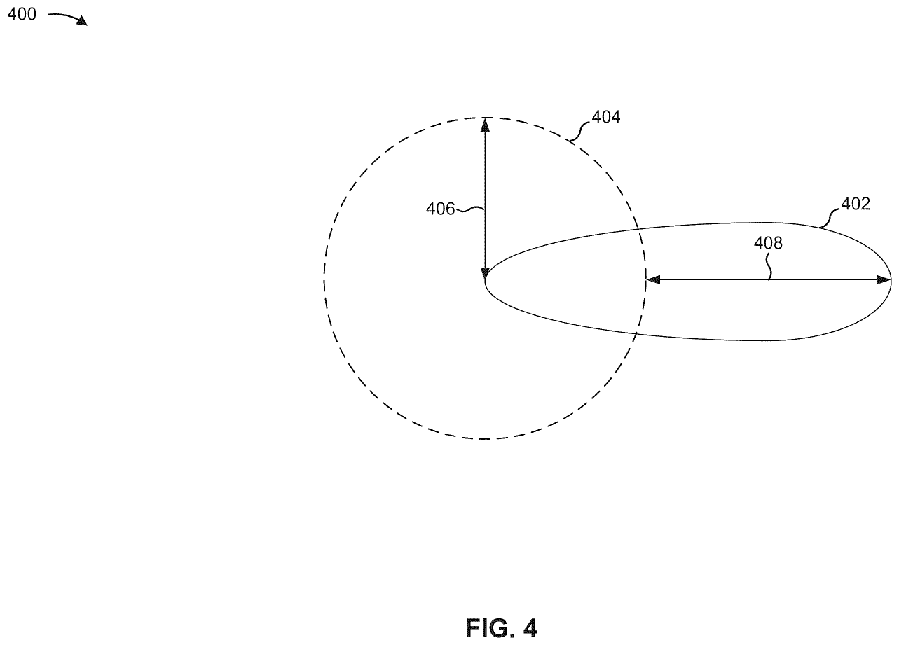

FIG. 4 is a diagram illustrating an example 400 of EIRP, in accordance with the present disclosure.

EIRP is a measurement metric that indicates a total radiated power of an antenna system when transmitted by a hypothetical isotropic antenna system that transmits an electromagnetic wave uniformly in all directions. Using a hypothetical isotropic antenna system to characterize a total radiated power provides a baseline and/or reference for analyzing antenna gain. In some aspects, EIRP may be calculated based at least in part on a transmitted power level, an antenna gain, and/or signal loss (e.g., due to cables and/or connectors), and may provide an indication of an antenna system's measure of coverage and/or interference management. Typically, EIRP has a measurement unit of decibels to one milliwatt (dBm).

The example 400 includes a two-dimensional representation of a first radiation pattern 402 (shown with a solid line) by an antenna system that is directional. That is, the first radiation pattern 402 may be a radiation pattern for a beamformed signal that has signal strength in a first direction and/or does not have signal strength in a second direction. In some aspects, a second radiation pattern 404 (shown with a dotted line) has an equivalent signal power level as the first radiation pattern 402, where the second radiation pattern 404 is based at least in part on a transmission by a hypothetical isotropic antenna system. The second radiation pattern 404 may be characterized based at least in part on an isotropic antenna gain 406 that may be used at a baseline (e.g., decibels relative to an isotropic antenna (dBi)). The first radiation pattern 402 may be characterized by a gain 408 that is relative to the isotropic antenna gain 406 (e.g., X dBi, where X is a real number).

To ensure that the operation of a wireless network is reliable and/or safe, some regulating bodies (e.g., the Federal Communications Commission (FCC), the European Telecommunications Standards Institute (ETSI), the International Telecommunication Union (ITU), 3GPP, the Ministry of Industry and Information Technology (MIIT), and/or the Telecom Regulatory Authority of India (TRAI)) may specify an operating condition that is based at least in part on EIRP. As one example, a regulatory body may specify, as a condition to operate in a wireless network (e.g., a regulatory limitation), that a wireless communication device should comply with an EIRP mask to mitigate interference and/or to manage coexistence of multiple wireless communication devices operating within the wireless network. For instance, an EIRP mask may specify respective worst-case thresholds and/or respective average EIRP thresholds for varying directions. That is, the EIRP mask may specify an EIRP threshold that indicates how much transmit power (e.g., a maximum transmit power and/or an average transmit power) a wireless communication device is allowed to transmit in a certain direction.

For instance, in a scenario that includes elevation transmissions (e.g., satellites, drones, and/or other aerial objects), an EIRP mask may bound (e.g., limit) interference generated by an aggressor wireless communication device and/or observed by a potential victim wireless communication device. “Victim wireless communication device” may denote a wireless communication device that experiences and/or observes signal degradation due to interference, and “aggressor wireless communication device” may denote a wireless communication device that causes the interference. The use of an EIRP mask for elevation transmissions may be applicable for C-band transmissions (e.g., in the 3.7 GHz to 4.2 GHz range) that might otherwise create interference to radio altimeters that operate in the 4.2 to 4.4 GHz frequency range. Thus, EIRP masks may be useful for frequency bands that are used for different services, such as 5G C-band transmissions and radio altimeters.

Evolving radio technologies may share frequency bands in a similar manner as described above. As one example, evolving radio technologies may explore communications in FR3 (e.g., 7.125 GHZ-24.25 GHZ), and some intermediate frequencies (IFs) of one or more FR2 services may be located in FR3. Accordingly, some services may coexist in FR3, and the use of an EIRP mask for FR3 (and/or other frequency bands with coexisting services) may mitigate interference, reduce recovery errors, and/or increase data throughput in a wireless network. However, a first EIRP mask specified for FR3 transmissions may differ from a second EIRP mask specified for FR2 transmissions. To illustrate, FR3 transmissions and/or systems may have different properties relative to FR2 transmissions and/or systems, such as hardware (e.g., multi-panel transmissions), wavelength, bandwidth, and/or range. Accordingly, a regulatory body may specify different EIRP masks for different operating conditions (e.g., the first EIRP mask for FR3 transmissions and the second EIRP mask for FR2 transmissions).

“Conformance testing,” which may also be referred to as compliance testing, denotes a process and/or procedure that may be used to verify compliance with an operating condition, such as a regulatory limitation that is specified by a regulatory body. In some aspects, a network node manufacturer and/or a UE manufacturer may perform conformance testing to validate that a network node and/or a UE acting as an aggressor wireless communication device, respectively, is compliant with an EIRP threshold and/or an EIRP mask. As radio technologies advance to using higher frequencies, a regulatory body may specify an updated EIRP mask that is based at least in part on the higher frequencies. Updates to an EIRP mask may result in updates to a conformance testing procedure in order to verify compliance with the updated EIRP mask.

As one example, a conformance test may include a test equipment transmitting reference signals using a first polarization, and a wireless communication device (e.g., a UE 120 and/or a network node 110) selecting a beam pair using the reference signals while operating at a first location. Using the selected beam pair, the wireless communication device may transmit K beams for M elevation angles and N azimuth angles, where K, M, and N are integers, and the test equipment may generate a measurement metric for each sampling point (e.g., each unique combination of a beam, an elevation angle, and an azimuth angle). To illustrate, at the first location, the wireless communication device may change orientations by switching to (and transmitting at) each of the M elevation angles for a first azimuth angle, switching to (and transmitting at) each of the M elevation angles for a second azimuth angle, up to switching to (and transmitting at) each of the M elevation angles for an N-th azimuth angle. At each orientation, the wireless communication device may transmit K beams using the first polarization and/or test beamforming vectors, and the test equipment may generate a measurement. That is, at a first elevation angle and a first azimuth angle, the wireless communication device may transmit K beams, and at a second elevation angle and the first azimuth angle, the wireless communication device may transmit K beams. Accordingly, at the location and the first polarization, the wireless communication device may transmit a first set of KMN beams, and the test equipment may generate a first set of KMN measurement metrics. The process may repeat such that the wireless communication device transmits, while operating at the first location, a second set of KMN beams using a second polarization, and the test equipment may generate a second set of KMN measurement metrics. Alternatively, or additionally, the wireless communication device may move from the first location to a second location and repeat transmitting the first set of KMN beams using the first polarization and the second set of KMN beams using the second polarization. The test equipment may generate a third set of KMN measurement metrics and a fourth set of KMN measurement metrics using the beams transmitted by the wireless communication device at the second location.

The wireless communication device may move to multiple locations and repeat transmission of the first set of KMN beams and the second set of KMN beams, and the testing equipment may generate corresponding sets of measurement metrics, which may be significant in various scenarios. For instance, the number of beams (e.g., K), the number of elevation angles (e.g., M), and the number of azimuth angles (e.g., N) may be based at least in part on a portion of the sphere that is used to validate compliance. Some factors may increase the number of transmissions and/or measurement metrics, such as the number of beams increasing as an antenna array size increases and/or the number of elevation angles and/or the number of azimuth angles increasing to obtain a finer resolution and/or increase a precision. The increases in the number of beams, the number of elevation angles, the number of azimuth angles, and/or the number of locations may extend a duration of a compliance test, increase resource consumption (e.g., air interface resources, personnel resources, and/or power resources), increase a complexity of analyzing the measurement results, and/or increase a complexity of configuring the compliance test.

Alternatively, or additionally, difficulties arise in selecting which elevation angles and/or which azimuth angles to use as part of the K beams, the M elevation angles, and/or the N azimuth angles. To illustrate, the wireless communication device under test transmits K beams (e.g., using test beamforming vectors), rotates between M elevation angles, and rotates between N azimuth angles to simulate various operating orientations, but a practical operating orientation (e.g., a particular beam, a particular elevation angle, and/or a particular azimuth angle) may be unclear, resulting in uncertainty between EIRP conformance testing results and compliance with an operating condition in a real-world deployment. In some aspects, the test beamforming vectors may vary from beamforming codebooks utilized in a practical deployment scenario, which may also lead to uncertainty between EIRP mask conformance testing results and compliance with an operating condition in a real-world deployment. The uncertainty may result in a failure to comply with an EIRP mask, particularly for EIRP conformance testing of a network node, in a real-world deployment, resulting in signal degradation (e.g., increased interference), increased recovery errors, and/or decreased data throughput in a wireless network.

Various aspects relate generally to EIRP mask conformance testing for a network node using an LEN. Some aspects more specifically relate to an LEN and test equipment changing orientations to test transmission by the network node. In some aspects, an LEN may transmit, using a first polarization, one or more reference signals that are configured for an EIRP mask conformance testing procedure for a network node. Based at least in part on expiration of a beam selection timer, the LEN may transmit a beam lock command that is directed to the network node. The beam selection timer may be based at least in part on a duration used by the network node to select a beam pair. In some aspects, the network node may select the beam pair using one or more measurement metrics that are generated using the reference signal(s). Based at least in part on transmitting the beam lock command, the LEN may transmit an indication of an uplink grant that is configured for the EIRP mask conformance testing procedure and is assigned to the network node. In some aspects, the uplink grant may include a number of resources that are based at least in part on a number of transmissions generated by the network node and/or measurement metrics generated by a test equipment. The LEN may repeat transmitting the reference signal(s) as described above using a second polarization, may repeat transmitting the commands, may repeat transmitting an uplink grant, and/or may repeat an entirety of the process based at least in part on changing an orientation as described below. Repeating one or more aspects of the process may include some variations, such as transmitting a different uplink grant configuration and/or transmitting a different reference signal.

In some aspects, a network node may receive one or more reference signals that have a first polarization, and the one or more reference signals may be configured for an EIRP mask conformance testing procedure for the network node. To illustrate, the one or more reference signals may use a variety of beams that are based at least in part on a portion of a sphere being tested in the EIRP conformance testing procedure. The network node may receive a beam lock command that indicates to select a locked beam pair. In some aspects, the network node may select the locked beam pair using one or more measurement metrics generated using the reference signal(s). Based at least in part on receiving the beam lock command and/or selecting the locked beam pair, the network node may receive an uplink grant that is configured for the EIRP mask conformance testing procedure and is assigned to the network node. In some aspects, the network node may transmit one or more transmissions using the locked beam pair.

In some aspects, a test equipment may receive an indication to initiate a measurement cycle that is at least part of an EIRP mask conformance testing procedure for a network node. As at least part of the measurement cycle, the test equipment may operate at a first orientation and may generate first one or more measurement metrics, such as power level measurement metrics and/or interference level measurement metrics. The first orientation of the test equipment may include an elevation angle, an azimuth angle, an axis of rotation, and/or an angle of rotation around the axis of rotation. Alternatively, or additionally, the first orientation may include a location of the test equipment. In some aspects, the test equipment may reconfigure to at least a second orientation, and may generate, at the second orientation, second one or more measurement metrics. The first measurement metric(s) and the second measurement metric(s) may be used to verify compliance (or not) with an EIRP mask.

Particular aspects of the subject matter described in this disclosure can be implemented to realize one or more of the following potential advantages. In some examples, by using an LEN, the described techniques can be used to enable EIRP conformance testing that verifies whether a network node is compliant with an EIRP operating condition, such as an EIRP mask specified by a regulatory body. More particularly, the LEN may function as a UE (e.g., a virtual UE that models a UE in a practical deployment scenario for the network node) that establishes a connection with the network node, and the network node may communicate with the LEN using a beamforming codebook. In some aspects, the beamforming codebook may be used by the network node in a practical and/or real-world deployment scenario in which the network node provides service to one or more UEs. That is, the beamforming codebook may include beam weights that may be used by the network node in a scenario where the network node is a potential aggressor node, resulting in EIRP compliance testing results that align more with a real-world deployment scenario relative to an EIRP conformance testing procedure that uses beams that are configured via test beamforming vectors that are not used by the network node in the wireless network and/or real-world deployment. EIRP compliance testing results that align with a real-world deployment scenario may reduce an uncertainty in the results, leading to compliance with an EIRP mask in the real-world deployment, reduced signal degradation, reduced recovery errors, and/or increased data throughput in a wireless network.

As part of the EIRP conformance testing, the LEN and/or the test equipment may rotate around respective axes in a manner that replicates potential locations of UEs in communication with the network node and/or victim UEs. That is, the LEN and/or the test equipment may be positioned at the locations and/or orientations of the UEs and/or victim UEs, which provides more certainty between an EIRP conformance testing result and real-world deployment, relative to an EIRP conformance testing result that is based at least in part on rotating a wireless communication device under test without certainty as to which orientation simulates a real-world deployment. Alternatively, or additionally, the ability to position the LEN and/or test equipment at the locations and/or orientations of the UEs and/or victim UEs may lead to using fewer beams, fewer elevation angles, and/or fewer azimuth angles, relative to rotating the wireless communication device under test, resulting in a shorter duration for an EIRP conformance testing procedure, decreased complexity of analyzing the measurement results, and/or decreased complexity of configuring the compliance test times.

As indicated above, FIG. 4 is provided as an example. Other examples may differ from what is described with regard to FIG. 4.

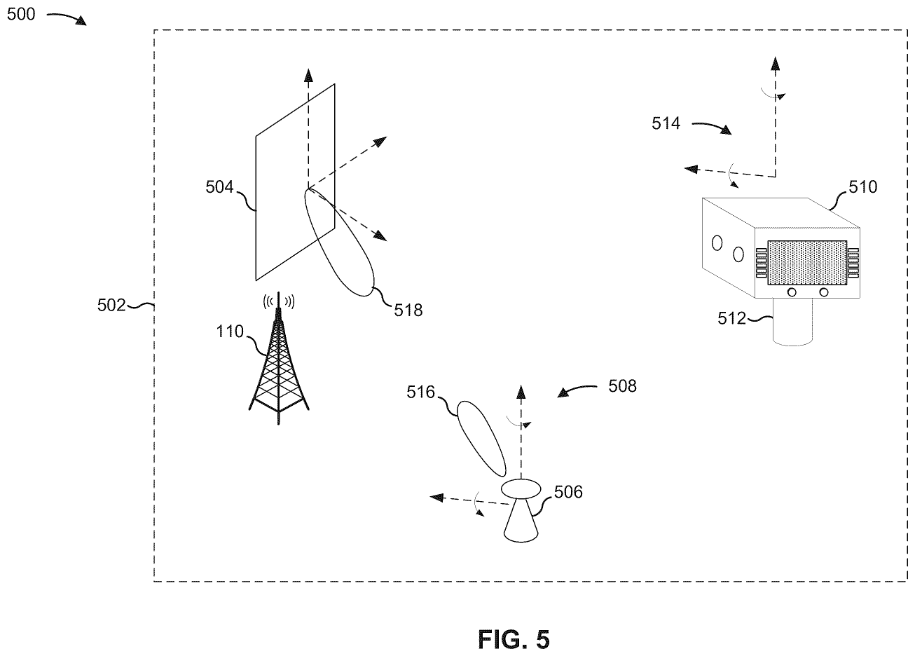

FIG. 5 is a diagram illustrating an example 500 of a conformance test environment, in accordance with the present disclosure.

The example 500 includes a conformance test environment 502 that may be used for implementing a conformance testing procedure, such as an EIRP conformance testing procedure that verifies compliance with an EIRP mask, as described herein. The conformance test environment 502 includes a network node 110, and the network node 110 includes an antenna panel 504 (which may alternatively or additionally be an antenna array) that includes a capability to transmit signals using different polarizations. In some aspects, the antenna panel 504 may be a dual-polarized antenna panel that includes a capability to transmit a first signal using a first polarization and a second signal using a second polarization. Accordingly, the network node 110 may include a capability to dynamically configure and/or reconfigure which polarization is used for a transmission.

The conformance test environment 502 also includes an LEN 506. In some aspects, the LEN 506 may include at least some hardware and/or functionality that is included in a UE 120, such as that described with regard to FIG. 1 and FIG. 2. In some aspects, the LEN 506 may include any combination of one or more antennas 252, one or more modems 254, a MIMO detector 256, a receive processor 258, a data sink 260, a data source 262, a transmit processor 264, a TX MIMO processor 266, a controller/processor 280, a memory 282, and/or a communication manager 140. Accordingly, the LEN 506 may include an ability to encode, modulate, transmit, receive, demodulate, and/or decode transmissions, such as a transmission that is configured based at least in part on a particular RAT (e.g., 5G and/or 6G). As shown by reference number 508, the LEN 506 may include an ability to dynamically change an orientation, such as a rotation around a horizontal axis (e.g., an azimuth rotation) and/or a rotation around a vertical axis (e.g., an elevation rotation). Such rotations may, collectively, be characterized at least in part using a rotation vector and a rotation angle. In some aspects, the LEN 506 may be mobile and/or include an ability to change locations. Accordingly, an orientation for the LEN 506 as described herein may include a particular elevation angle, a particular azimuth angle, and/or a particular location, and an orientation change may include a change in the elevation angle, a change in the azimuth angle, and/or a change in location.

The conformance test environment 502 also includes a test equipment 510. In a similar manner as the LEN 506, the test equipment 510 may include at least some hardware and/or functionality in a UE 120 that enables the test equipment to transmit and/or receive wireless signals, such as any combination of one or more antennas 252, one or more modems 254, a MIMO detector 256, a receive processor 258, a data sink 260, a data source 262, a transmit processor 264, a TX MIMO processor 266, a controller/processor 280, a memory 282, and/or a communication manager 140. In some aspects, the test equipment 510 may include and/or be mounted to a fixture 512 that enables the test equipment 510 to change orientations, such as a rotation around a horizontal axis (e.g., an azimuth rotation) and/or a rotation around a vertical axis (e.g., an elevation rotation) as shown by reference number 514. Alternatively, or additionally, the test equipment 510 may be mobile and/or include an ability to change locations. Accordingly, an orientation for the test equipment 510 as described herein may include a particular elevation angle, a particular azimuth angle, and/or a particular location, and an orientation change may include a change in the elevation angle, a change in the azimuth angle, and/or a change in location.

In the conformance test environment 502, the network node 110 may be tested via a conformance testing procedure to verify whether the network node 110 is in compliance with an operating condition, such as an EIRP mask operating condition that is specified by a regulatory body. Accordingly, the network node 110 may be configured to behave as an aggressor wireless communication device. As part of the conformance testing procedure, the network node 110 may be positioned at a particular location and/or with a specific orientation (e.g., elevation angle and/or azimuth angle) relative to the LEN 506.

In some aspects, as part of a conformance testing procedure, the LEN 506 may transmit one or more reference signals as shown by reference number 516. As one example, the LEN 506 may repeatedly transmit a same reference signal using a same transmission configuration (e.g., a same frequency) and/or a same beam (e.g., a same direction and/or a same beamwidth). As another example, the LEN 506 may transmit the reference signal(s) using varying transmission configurations (e.g., varying frequencies) and/or different beams (e.g., different directions and/or different beamwidths). In some aspects, the LEN 506 may repeatedly and/or iteratively transmit the reference signal(s) using a same polarization. Examples of reference signals may include a sounding reference signal (SRS) and/or a synchronization signal block (SSB).

The network node 110 may use different beams to receive the reference signal(s) and/or generate a respective measurement metric for each beam used to receive a respective reference signal, such as an RSRP metric and/or an RSSI metric. Alternatively, or additionally, the network node 110 may use different polarizations to receive the reference signal(s) and/or may generate a respective measurement metric for each polarization. To illustrate, the network node 110 may receive a first reference signal (and/or a first portion of a reference signal) using a first polarization, and may generate a first measurement metric based at least in part on the first polarization and the first reference signal. The network node 110 may receive the same reference signal (or another reference signal configured with the same transmission characteristics) using a second polarization, and may generate a second measurement metric based at least in part on the second polarization. In some aspects, the network node 110 may configure the receive beams using a beamforming codebook that is used in a practical and/or real-world deployment in which the network node 110 provides services to one or more UEs.

By generating a respective measurement metric for each beam, the network node 110 may select a beam configuration and/or a beam pair that is associated with a highest signal quality (e.g., a highest received signal power level). An example beam pair may be a receive beam that is associated with the highest measurement metric (e.g., the highest signal quality) out of a set of measurement metrics and a transmit beam that is based at least in part on reciprocity with the receive beam. In some aspects, the network node 110 may select a beam pair based at least in part on both polarizations, such as by generating an average measurement metric for each beam using a first measurement metric associated with the first polarization and a second measurement metric associated with the second polarization. Accordingly, the network node 110 may select a beam configuration and/or a beam pair by selecting a beam associated with the highest signal quality indicated by the average measurement metric. However, other types of measurement metrics and/or other computations may be used, such as a median, a standard deviation, clustering, prioritization, and/or a decision tree. In a scenario with an unobstructed path between the LEN 506 and the network node 110, the selected beam pair may be based at least in part on a beam that is the most correlated beam (e.g., out of a set of beams used by the network node 110) to the unobstructed directional link from LEN 506. An example of a beam at the network node 110 that is most correlated to a beam used by the LEN 506 to transmit the reference signal(s) is shown by reference number 518.

As part of the conformance testing procedure, the LEN 506 may wait for a duration (e.g., 3 seconds, 5 seconds, and/or 1 second) to allow the network node 110 time to select a beam pair (e.g., a beam pair that provides the highest signal quality). As one example, the LEN 506 may activate a beam selection timer that is configured for the duration. Upon expiration of the beam selection timer, the LEN 506 may transmit (e.g., via a wireless link established with the network node 110) a beam lock command that indicates to use the selected beam pair for one or more transmissions and/or to not change from the selected beam pair. That is, the beam lock command indicates to lock in using the selected beam pair and to not change to using another beam unless directed otherwise (e.g., by a command and/or a timer expiration). The beam selection timer may be configured using a duration configuration that is specified by a communication standard, a regulatory body, and/or user input. Alternatively, or additionally, the duration configuration may be indicated by the network node 110 (e.g., RRC configured). The network node 110 configuring a duration of the beam selection timer may enable the network node 110 to select a duration that is based at least in part on capabilities at the network node 110.

Based at least in part on transmitting the beam lock command, the LEN 506 may transmit, and the network node 110 may receive, an indication of an uplink grant that is assigned to the network node 110. In some aspects, the uplink grant may be configured based at least in part on the conformance testing procedure (e.g., an EIRP conformance testing procedure that verifies compliance with an EIRP mask). To illustrate, the uplink grant may assign a number of air interface resources to the network node 110, where the number of air interface resources is configured based at least in part on a number of beams (e.g., K beams) transmitted by the network node 110 during at least part of the conformance testing procedure. Alternatively, or additionally, the number of air interface resources may be based at least in part on a number of elevation angles used by the test equipment 510 to generate measurement metrics, a number of azimuth angles used by the test equipment 510 to generate measurement metrics, and/or a number of transmission polarizations used by the network node 110 during at least part of the conformance testing procedure. The uplink grant may be configured as a dynamic grant and/or a semi-persistent grant (e.g., a configured grant).

The network node 110 may generate one or more transmissions using the uplink grant. As one example, the network node 110 may transmit a reference signal using the locked beam pair (e.g., a transmit beam that is based at least in part on reciprocity with a receive beam) and the uplink grant. In some aspects, the network node 110 may alternate between using a first polarization to transmit the reference signal and a second polarization to transmit the reference signal. As described above, the network node 110 may form the locked beam pair using a beamforming codebook that is used in a practical and/or real-world deployment.

As at least part of the conformance testing procedure, the test equipment 510 may rotate around one or more axes as shown by reference number 514. At each orientation, the test equipment 510 may generate a measurement metric. Alternatively, or additionally, the test equipment 510 may generate multiple measurement metrics at each orientation, such as a first measurement metric based at least in part on receiving a first transmission that uses a first polarization and a second measurement metric based at least in part on receiving a second transmission that uses a second polarization. As an example, the test equipment 510 may generate a respective RSRP measurement metric for each polarization. Alternatively, or additionally, the test equipment 510 may use the measurement metrics to derive and/or estimate an EIRP metric associated with the network node 110, where the EIRP metric may be based at least in part on the locked beam pair and/or an orientation of the network node 110. An EIRP metric for a particular locked beam pair, a particular orientation of the network node 110, and/or a particular polarization transmitted by the network node may be represented as:

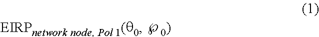

where the subscript “network node” denotes that the EIRP measurement metric is for the network node, the subscript “Pol 1” denotes a polarization (e.g., a first polarization), θ₀ represents an elevation angle of the test equipment 510, and φ₀ represents an azimuth angle of the test equipment 510. In some aspects, θ₀ and φ₀ may have respective ranges as follows: θ_{L}≤θ₀≤θ_{U} and 0°≤φ₀≤360°, where the lower and upper bounds of θ₀ (e.g., θ_{L} and θ_{U}) may be selected based at least in part on a real-world deployment model. Based at least in part on completion of a measurement cycle (e.g., the rotation through θ₀ and φ₀), the LEN 506 may transmit, and the network node 110 may receive, a beam unlock command that indicates to cease using the locked beam pair (e.g., selected by the network node 110 based at least in part on the first polarization).

The LEN 506, the network node 110, and the test equipment 510 may repeat selection of a locked beam pair and/or a measurement cycle based at least in part on using a second polarization. Alternatively, or additionally, the LEN 506, the network node 110, and the test equipment 510 may repeat selection of a locked beam pair and/or a measurement cycle based at least in part on changing a location and/or orientation of the LEN 506 and/or the test equipment 510. As one example, the LEN 506 may transmit one or more reference signals using a second polarization and the network node 110 may receive the reference signal(s) using a variety of beams. The LEN 506 may transmit, and the network node 110 may receive, a second beam lock command, and the network node 110 may select a second beam pair based at least in part on the measurement metric(s) generated using the reference signals(s) transmitted using the second polarization. The LEN 506 may transmit a second uplink grant that is assigned to the network node 110, and the network node 110 may transmit using the second uplink grant. Alternatively, or additionally, the test equipment 510 may generate one or more measurement metrics that may be used to derive an EIRP measurement metric associated with the network node 110, that may be represented as:

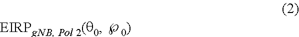

Alternatively, or additionally, the LEN 506 may change locations, change an elevation angle, and/or change an azimuth angle (e.g., that represent a potential location of a UE 120), and the LEN 506, the network node 110, and the test equipment 510 may repeat selection of a locked beam pair and/or a measurement cycle based at least in part on using a first polarization and/or a second polarization. As described herein, the range of angles used to orientate and/or reorientate the LEN 506 may be commensurate (e.g., within a threshold and/or within a range of values) to real-world deployment UE locations, such as a first orientation that is commensurate with a UE being located below a horizontal plane of the network node (e.g., a horizontal plane of a main lobe of a transmission) to characterize a high-rise deployment scenario, and/or a second orientation that is commensurate with a UE being located on a same floor and/or in a same horizontal plane of the network node.

Using an LEN in a compliance testing procedure for a network node may generate EIRP compliance testing results that align more with a real-world deployment scenario as described herein. In some aspects, the LEN may function as a UE that establishes a connection with the network node, and the network node may communicate with the LEN using a beamforming codebook used by the network node in a practical and/or real-world deployment scenario. EIRP compliance testing results that align with a real-world deployment scenario may reduce an uncertainty in the results, leading to compliance with an EIRP mask in the real-world deployment, reduced signal degradation, reduced recovery errors, and/or increased data throughput in a wireless network. Alternatively, or additionally, the LEN may rotate around respective axes in a manner that replicates potential locations of UEs in communication with the network node. The ability to position the LEN at the locations and/or orientations of the UEs and/or victim UEs may lead to using fewer beams, fewer elevation angles, and/or fewer azimuth angles relative to rotating the wireless communication device under test, resulting in a shorter duration for an EIRP conformance testing procedure, decreased complexity of analyzing the measurement results, and/or decreased complexity of configuring the compliance test times.

As indicated above, FIG. 5 is provided as an example. Other examples may differ from what is described with regard to FIG. 5.

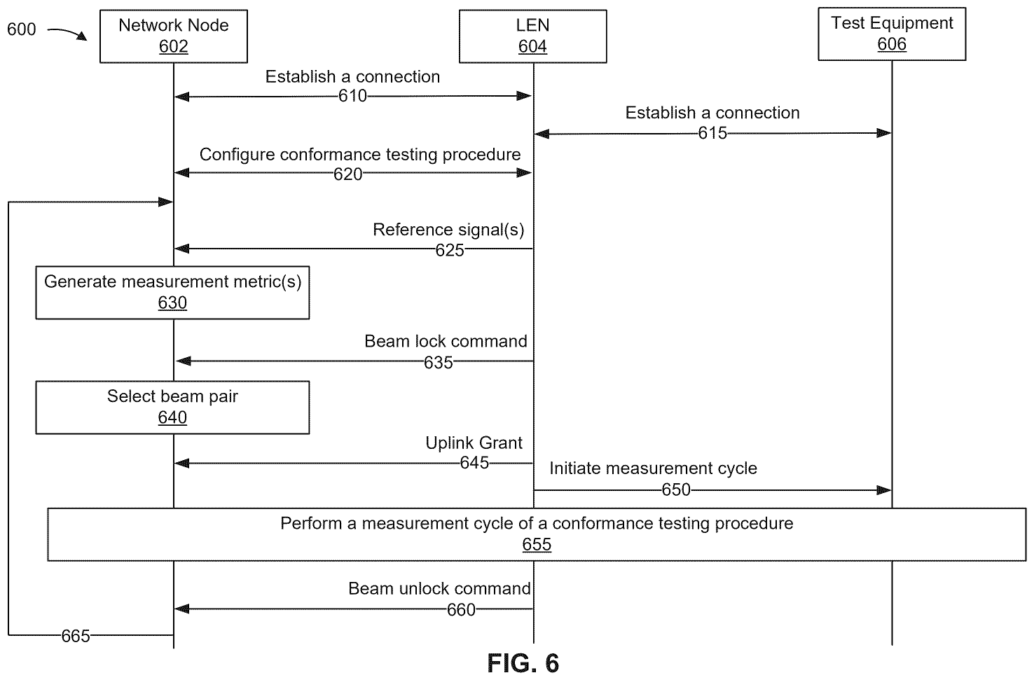

FIG. 6 is a diagram illustrating an example 600 of a wireless communication process between a network node 602 (e.g., the network node 110), an LEN 604 (e.g., an apparatus 1100), and test equipment 606 (e.g., an apparatus 1300), in accordance with the present disclosure.

As shown by reference number 610, a network node 602 and an LEN 604 may establish a connection. In some aspects, the LEN 604 may be a UE 120 and/or include at least some functionality of a UE 120 as described above, and the network node 602 and the LEN 604 may establish, as the connection, a wireless link. For instance, the LEN 604 and the network node 602 may perform one or more procedures (e.g., a random access channel (RACH) procedure and/or an RRC procedure) to establish a wireless link. Alternatively, or additionally, the network node 602 and the LEN 604 may communicate via the connection based at least in part on any combination of Layer 1 signaling (e.g., downlink control information (DCI) and/or uplink control information (UCI)), Layer 2 signaling (e.g., a MAC control element (CE)), and/or Layer 3 signaling (e.g., RRC signaling).

As shown by reference number 615, the LEN 604 and a test equipment 606 may establish a connection. In some aspects, the test equipment 606 may be a UE 120 and/or include at least some functionality of a UE 120 as described above, and the LEN 604 and the test equipment 606 may establish, as the connection, a wireless link, such as a sidelink. Alternatively, or additionally, the LEN 604 and the test equipment 606 May establish a connection through a wired link. While the example 600 includes the LEN 604 and the test equipment 606, other examples may not include the LEN 604 and the test equipment 606 establishing a connection.

As shown by reference number 620, the network node 602 and the LEN 604 may configure a conformance testing procedure, such as an EIRP conformance testing procedure that is based at least in part on validating whether the network node 602 is compliant with an EIRP mask. As one example, the LEN 604 may transmit an indication to initiate the conformance testing procedure, a beam selection sub-procedure of the conformance testing procedure, and/or a measurement cycle of the conformance testing procedure. Alternatively, or additionally, the LEN 604 may transmit an indication of a reference signal configuration (e.g., an air interface resource, a frequency domain allocation, a time domain allocation, a reference signal type, and/or a resource mapping) for one or more reference signals transmitted by the LEN 604. Alternatively, or additionally, the network node 602 may transmit an indication of one or more capabilities, such as an antenna configuration (e.g., a number of antenna panels, a number of antenna arrays and/or a number of antenna elements), a number of supported multiple-input multiple-output (MIMO) layers, a number of supported bandwidth parts (BWPs), and/or carrier aggregation support (e.g., a number of supported aggregated carriers, a supported RAT version, and/or supported frequency bands that can be aggregated). In some aspects, the network node 602 may transmit an indication of a beam selection duration (e.g., a duration configuration that indicates a time span used by the network node to select a beam pair from multiple beams). In some aspects, the network node 602 may transit the indication of the capabilities as part of establishing a connection with the LEN 604.

As shown by reference number 625, the LEN 604 may transmit, and the network node 602 may receive, one or more reference signals. Alternatively, or additionally, the LEN 604 may support multiple polarizations, and may transmit the reference signals using a first polarization of the multiple polarizations. As one example, the LEN 604 may transmit one or more SSBs that are configured for the EIRP conformance testing procedure, such as by transmitting a number of SSBs that are based at least in part on a number of receive beams used by the network node 602 as at least part of a beam selection sub-procedure. Alternatively, or additionally, the LEN 604 may transmit the reference signal(s) for a duration that is indicated by a beam selection timer. For instance, the LEN 604 may set a beam selection timer based at least in part on a duration that is indicated by any combination of the network node 602, a communication standard, and/or user input, and the LEN 604 may transmit the reference signal(s) for the duration. That is, the LEN 604 may iteratively and/or repeatedly transmit the reference signal(s) until expiration of the beam selection timer. In some aspects, the LEN 604 may iteratively and/or repeatedly transmit a same reference signal (e.g., a same reference signal type, a same frequency, and/or a same air interface element), while in other aspects, the LEN 604 may transmit different reference signals.

As shown by reference number 630, the network node 602 may generate one or more measurement metrics using the reference signal(s) transmitted by the LEN 604. To illustrate, the network node may use multiple potential beams to receive the reference signal(s), such as by using a first potential receive beam to receive a first reference signal (and/or a first portion of a reference signal), a second potential receive beam to receive a second reference signal (and/or a second portion of the reference signal), up to an N-th receive beam to receive an N-th reference signal (and/or an N-th portion of the reference signal), where Nis an integer. In some aspects, the network node 602 may form the potential receive beams using a beamforming codebook that is configured for use by the network node 602 in a real-world deployment. Alternatively, or additionally, the network node 602 may use multiple polarizations to receive the reference signal(s), such as by using a first polarization to receive a reference signal and a second polarization to receive the same reference signal (and/or an instance of the reference signal). “Potential receive beam” may denote a beam that the network node 602 may select to use as part of a locked beam pair as described below.

The network node 602 may generate a respective measurement metric using the respective reference signal (and/or respective reference signal portion) received via each potential receive beam. To illustrate, the network node 602 may generate an RSRP measurement metric and/or an RSSI measurement metric using the respective reference signal. In some aspects, the network node 602 may generate a first measurement metric that is associated with receiving a reference signal via a first polarization and a potential receive beam, and a second measurement metric that is associated with receiving the reference signal (and/or an instance of the reference signal) via a second polarization and the potential receive beam. The network node 602 may generate multiple measurement metrics, such as the first measurement metric associated with the first polarization and the second measurement metric associated with the second polarization, for each potential receive beam used by the network node 602.

As shown by reference number 635, the LEN 604 may transmit, and the network node 602 may receive, a beam lock command that is directed to the network node 602. As one example, the LEN 604 may transmit the beam lock command based at least in part on expiration of a beam selection timer. As another example, the LEN 604 may transmit the beam lock command based at least in part on a reference signal allocation expiring and/or completing. The LEN 604 may transmit the beam lock command using Layer 1 signaling, Layer 2 signaling, and/or Layer 3 signaling.

As shown by reference number 640, the network node 602 may select a beam pair. For instance, based at least in part on receiving the beam lock command, the network node 602 may analyze the multiple measurement metrics generated as described with regard to reference number 630, and select a receive beam (e.g., from multiple potential receive beams) that is associated with a highest signal quality, such as the receive beam that has a highest received power level out of the multiple potential receive beams. In some aspects, and as described above, the network node 602 may generate an average measurement metric for each potential receive beam using a first measurement metric associated with the first polarization and a second measurement metric associated with the second polarization, and the network node 602 may select a receive beam, a beam configuration, and/or a beam pair by selecting a beam associated with the highest signal quality indicated by the average measurement metric. However, other types of measurement metrics and/or other computations may be used by the network node 602 to select a beam, such as a median, a standard deviation, clustering, prioritization, and/or a decision tree. In some aspects, the network node 602 may derive a beam pair, such as by selecting a receive beam using a measurement metric as described above, and selecting a transmit beam in the beam pair using reciprocity with the receive beam. That is, the network node 602 may derive (and form) the transmit beam using reciprocity with the receive beam. The network node 602 may use a beamforming codebook to select, derive, and/or form the transmit beam. In some aspects, using the highest signal quality to select a receive beam may result in a beam pair with a highest correlation to a directional link that is associated with the LEN 604 and/or the reference signal(s) received by the network node 602.

As shown by reference number 645, the LEN 604 may transmit, and the network node 602 may receive, an indication of an uplink grant that is assigned to the network node 602 To illustrate, the LEN 604 may transmit an indication of an uplink grant that is configured for a measurement cycle and/or a measurement sub-procedure that is at least part of an EIRP conformance testing procedure, such as an uplink grant that includes a number of air interface resources that are based at least in part on a number of beams, a number of elevation angles, and/or a number of azimuth angles used in the measurement cycle. In some aspects, the LEN 604 may transmit the indication of the uplink grant based at least in part on transmitting the beam lock command and/or based at least in part on completion of a beam selection procedure by the network node 602. To illustrate, the network node 602 may transmit a confirmation to the beam lock command based at least in part on selecting a beam pair, and the LEN 604 may transmit the indication of the uplink grant based at least in part on receiving the confirmation.

As shown by reference number 650, the LEN 604 may communicate, and the test equipment 606 may receive, an indication to initiate a measurement cycle and/or a measurement sub-procedure that is at least part of a conformance testing procedure, such as an EIRP conformance testing procedure (e.g., an EIRP mask conformance testing procedure). As one example, the LEN 604 may transmit the indication via a wireless sidelink with the test equipment 606. As another example, the LEN 604 may transmit the indication via a wired link. While the example 600 includes the LEN 604 communicating the indication to initiate the measurement cycle to the test equipment 606, other examples may not include the LEN 604 communicating the indication to initiate the measurement cycle to the test equipment 606.

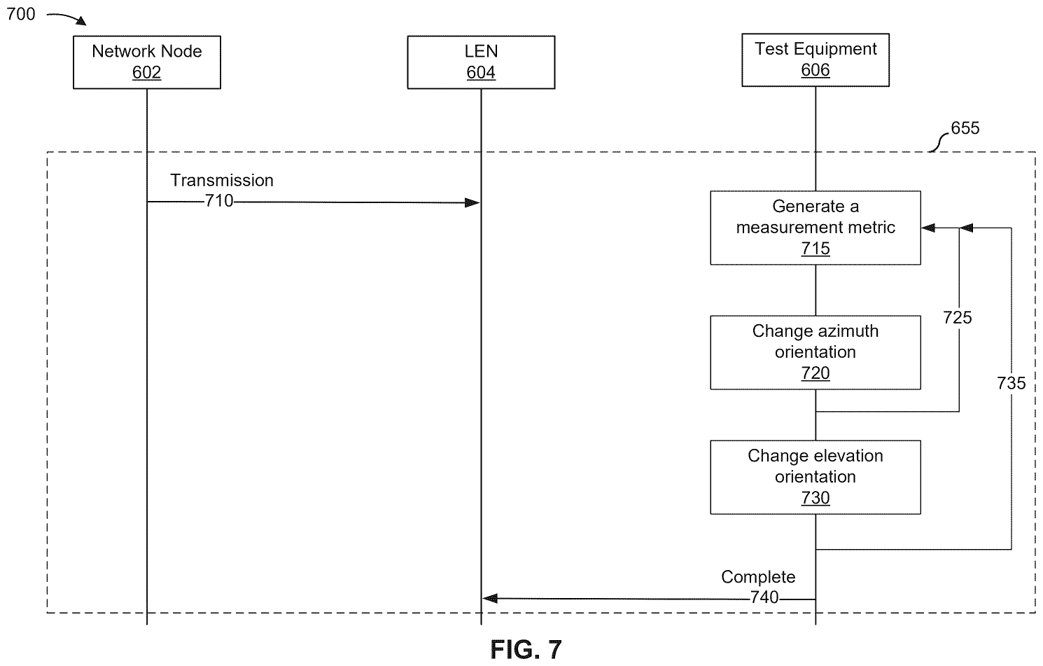

As shown by reference number 655, the network node 602, the LEN 604, and the test equipment 606 may perform a measurement cycle of a conformance testing procedure. An example of a measurement cycle is described below in more detail with regard to FIG. 7. As part of performing the measurement cycle, the network node 602 may transmit one or more transmissions using the locked beam pair. In some aspects, the transmissions may use a first polarization of multiple polarizations supported by the network node 602. Alternatively, or additionally, the test equipment 606 may generate first one or more measurement metrics based at least in part on operating in a first orientation (e.g., a first elevation angle and/or a first azimuth angle). The test equipment 606 may reconfigure to at least a second orientation (e.g., a second elevation angle and/or the first azimuth angle), and may generate second one or more measurement metrics based at least in part on operating in the second orientation. In some aspects, the LEN 604 may activate and/or start a measurement cycle timer that is configured for a measurement cycle duration.

In some aspects, the test equipment 606 may cycle through a set of elevation angles and/or a set of azimuth angles. Alternatively, or additionally, each orientation may include a location of the test equipment 606 and/or a rotation vector of the test equipment. As described above, a rotation vector may be characterized based at least in part on an axis of rotation, and an angle of rotation around the axis of rotation. To illustrate, the axis of rotation may be based at least in part on an elevation angle and/or an azimuth angle. An example of a measurement metric generated by the test equipment 606 includes a received signal power metric, and the test equipment 606 may use the measurement metric(s) to generate a compliance metric, such as an EIRP metric. As described below with regard to FIG. 7, the compliance metric may be based at least in part on multiple iterations of a measurement cycle.

As shown by reference number 660, the LEN 604 may transmit, and the network node 602 may receive, a beam unlock command that is directed to the network node 602. To illustrate, the LEN 604 may transmit the beam unlock command based at least in part on completion of the measurement procedure. In some aspects, the LEN 604 may receive, from the test equipment 606, a message that indicates completion of the measurement cycle, and the LEN 604 may transmit the beam unlock command based at least in part on receiving the message. Alternatively, or additionally, the LEN 604 may detect expiration of a measurement cycle timer, and transmit the beam unlock command based at least in part on the expiration.

As shown by reference number 665, the network node 602, the LEN 604, and/or the test equipment 606 may iteratively perform (e.g., repeat) at least portions of the wireless communication process described with regard to the example 600. As one example, the LEN 604 may transmit second one or more reference signals using a second polarization in a similar manner as described with regard to reference number 625, the network node 602 may generate one or more measurement metrics as described with regard to reference number 630, the LEN 604 may transmit a beam lock command as described with regard to reference number 635, the network node 602 may select a beam pair (e.g., using the measurement metrics based at least in part on the reference signals transmitted using the second polarization) in a similar manner as described with regard to reference number 640, and/or the LEN 604 may transmit an indication of a second uplink grant that is assigned to the network node 602 in a similar manner as described with regard to reference number 645. In some aspects, the LEN 604 may communicate an indication to initiate a measurement cycle to the test equipment 606, as described with regard to reference number 650, and the network node 602, the LEN 604, and/or the test equipment 606 may perform a measurement cycle as described with regard to reference number 655.

The network node 602, the LEN 604, and/or the test equipment 606 may iterate through multiple cycles as described with regard to reference number 660. In some aspects, based at least in part on completing a measurement cycle, the LEN 604 may change from operating in a first orientation to operating in a second orientation (e.g., a change in an elevation angle, a change in an azimuth angle, and/or a change in location), and network node 602, the LEN 604, and/or the test equipment 606 may iterate through at least portions of the wireless communication process described with regard to reference number 660. The network node 602, the LEN 604, and/or the test equipment 606 may iterate through multiple cycles for each orientation of the LEN 604, such as by iterating through a first cycle using a first polarization and a second cycle using a second polarization for each orientation of the LEN 604. Accordingly, the LEN 604 may repeat transmission of the reference signal(s) (e.g., using different polarizations), transmission of a beam lock command, and/or transmission of a respective uplink grant (e.g., that is configured for a measurement cycle of an EIRP conformance testing procedure) that is assigned to the network node. The network node 602 may repeat receiving reference signal(s), receiving a beam lock command, selecting a beam lock pair, receiving an uplink grant, and/or transmitting using a locked beam pair second. The test equipment 606 may repeat generating measurement metrics based at least in part on switching between multiple elevation angles and/or multiple azimuth angles. To illustrate, the test equipment 606 may generate a first set of measurements at a first elevation angle and switching between multiple azimuth angles and a second set of measurements at a second elevation angle and switching between multiple azimuth angles.

Using an LEN in a compliance testing procedure for a network node may generate EIRP compliance testing results that align more with a real-world deployment scenario as described herein. In some aspects, the LEN may function as a UE that establishes a connection with the network node, and the network node may communicate with the LEN using a beamforming codebook used by the network node in a practical and/or real-world deployment scenario. EIRP compliance testing results that align with a real-world deployment scenario may reduce an uncertainty in the results, leading to compliance with an EIRP mask in the real-world deployment, reduced signal degradation, reduced recovery errors, and/or increased data throughput in a wireless network. Alternatively, or additionally, the LEN may rotate around respective axes in a manner that replicates potential locations of UEs in communication with the network node. The ability to position the LEN at the locations and/or orientations of the UEs and/or victim UEs may lead to using fewer beams, fewer elevation angles, and/or fewer azimuth angles relative to rotating the wireless communication device under test, resulting in a shorter duration for an EIRP conformance testing procedure, decreased complexity of analyzing the measurement results, and/or decreased complexity of configuring the compliance test times.

As indicated above, FIG. 6 is provided as an example. Other examples may differ from what is described with regard to FIG. 6.

FIG. 7 is a diagram illustrating an example 700 of a wireless communication process between the network node 602, the LEN 604, and the test equipment 606 described with regard to FIG. 6, in accordance with the present disclosure. The example 700 shown by FIG. 7 includes at least portions of a wireless communication process that may be used by the network node 602, the LEN 604, and/or the test equipment 606 as part of performing a measurement cycle of a conformance testing procedure as described with regard to reference number 655.

As shown by reference number 710, the network node 602 may transmit one or more transmissions. In some aspects, the network node 602 may transmit the transmissions using an uplink grant from the LEN 604 as described with regard to reference number 645. The network node 602 may generate the transmission(s) using a particular polarization of multiple polarizations supported by the network node 602.

As shown by reference number 715, the test equipment 606 may generate one or more measurement metrics. For instance, the test equipment 606 may generate a received signal power metric that may be based at least in part on the transmissions generated by the network node 602. In some aspects, the test equipment 606 may generate the measurement metric(s) based at least in part on an orientation (e.g., an elevation angle and/or an azimuth angle) of the test equipment 606. To illustrate, the test equipment may use an initial elevation angle (e.g., out of M elevation angles) and an initial azimuth angle (e.g., out of N azimuth angles) for a first pass of generating a measurement metric.

As shown by reference number 720, the test equipment 606 may change an orientation by changing an azimuth angle and not changing a current elevation angle. In other examples, the test equipment 606 may change the orientation by changing the elevation angle and not changing the azimuth angle. As part of the measurement cycle, the test equipment 606 may be configured to switch between N azimuth angles.

As shown by reference number 725, the test equipment 606 may generate one or more measurement metrics in a similar manner as described with regard to reference number 715 using the updated orientation. The test equipment 606 may then change an orientation by changing an azimuth angle and not changing a current elevation angle. Accordingly, the test equipment 606 may iteratively cycle through and/or switch between the N azimuth angles, and generate one or more respective measurement metrics for each azimuth angle.

As shown by reference number 730, the test equipment 606 may change an orientation, such as by changing an elevation angle and/or resetting an azimuth angle to an initial azimuth angle.

As shown by reference number 735, the test equipment 606 may generate one or more measurement metrics in a similar manner as described with regard to reference number 715 using the updated orientation. The test equipment 606 may then change an orientation by changing an azimuth angle and not changing a current elevation angle. The test equipment 606 may cycle through and/or switch between the N azimuth angles, and generate one or more respective measurement metrics for each azimuth angle.

Based at least in part on cycling through the N azimuth angles, the test equipment 606 may change an orientation, such as by changing an elevation angle and/or resetting an azimuth angle to an initial azimuth angle. The test equipment 606 may iteratively cycle through and/or switch between the N azimuth angles for each elevation angle of the M elevation angles, and iteratively generate one or more respective measurement metrics for each azimuth angle/elevation angle combination.

As shown by reference number 740, the test equipment 606 may communicate, and the LEN 604 may receive, an indication that the measurement cycle has been completed. In some aspects, based at least in part on cycling through the M elevation angles and the N azimuth angles, the test equipment 606 may cease performing the measurement cycle and/or may transmit the indication. While the example 700 includes the test equipment 606 indicating completion of the measurement cycle, other examples may not include the test equipment 606 indicating completion of the measurement cycle.

As indicated above, FIG. 7 is provided as an example. Other examples may differ from what is described with regard to FIG. 7.

FIG. 8 is a diagram illustrating an example process 800 performed, for example, at an LEN or an apparatus of an LEN, in accordance with the present disclosure. Example process 800 is an example where the apparatus or the LEN (e.g., LEN 604 and/or apparatus 1100) performs operations associated with an EIRP conformance testing procedure for a network node using a LEN.

As shown in FIG. 8, in some aspects, process 800 may include transmitting, using a first polarization, one or more reference signals that are configured for an EIRP conformance testing procedure for a network node (block 810). In some aspects, the LEN (e.g., using transmission component 1104 and/or communication manager 1106, depicted in FIG. 11) may transmit, using a first polarization, one or more reference signals that are configured for an EIRP conformance testing procedure (e.g., an EIRP mask conformance testing procedure) for a network node, as described above.

As further shown in FIG. 8, in some aspects, process 800 may include transmitting, based at least in part on expiration of a beam selection timer, a beam lock command that is directed to the network node (block 820). In some aspects, the LEN (e.g., using transmission component 1104 and/or communication manager 1106, depicted in FIG. 11) may transmit, based at least in part on expiration of a beam selection timer, a beam lock command that is directed to the network node, as described above.

As further shown in FIG. 8, in some aspects, process 800 may include transmitting, based at least in part on transmitting the beam lock command, an indication of an uplink grant that is configured for the EIRP conformance testing procedure and is assigned to the network node (block 830). In some aspects, the LEN (e.g., using transmission component 1104 and/or communication manager 1106, depicted in FIG. 11) may transmit, based at least in part on transmitting the beam lock command, an indication of an uplink grant that is configured for the EIRP conformance testing procedure and is assigned to the network node, as described above.

Process 800 may include additional aspects, such as any single aspect or any combination of aspects described below and/or in connection with one or more other processes described elsewhere herein.

In a first aspect, the EIRP conformance testing procedure is based at least in part on validating compliance with an EIRP mask.

In a second aspect, the uplink grant is configured for a measurement cycle that is at least part of the EIRP conformance testing procedure, and process 800 includes transmitting, based at least in part on completion of the measurement cycle, a beam unlock command that is directed to the network node.

In a third aspect, the indication is a first indication, and process 800 includes transmitting a second indication to initiate a measurement cycle that is at least part of the EIRP conformance testing procedure, the second indication being directed to a test equipment.

In a fourth aspect, process 800 includes receiving, from the test equipment, a third indication that indicates completion of the measurement cycle, and transmitting, based at least in part on receiving the third indication, a beam unlock command that is directed to the network node.

In a fifth aspect, process 800 includes receiving a duration configuration for the beam selection timer, and configuring the beam selection timer to expire based at least in part on the duration configuration.

In a sixth aspect, transmitting the one or more reference signals using the first polarization includes transmitting the one or more reference signals for a duration that is indicated by the beam selection timer.

In a seventh aspect, the one or more reference signals are first one or more reference signals, the beam selection timer is a first beam selection timer, the beam lock command is a first beam lock command, and the indication of the uplink grant is a first indication of a first uplink grant, and process 800 includes transmitting, using a second polarization, second one or more reference signals that are configured based at least in part on the EIRP conformance testing procedure for the network node, transmitting, based at least in part on expiration of a second beam selection timer, a second beam lock command that is directed to the network node, and transmitting a second indication of a second uplink grant that is configured based at least in part on the EIRP conformance testing procedure and is assigned to the network node.

In an eighth aspect, the one or more reference signals include one or more synchronization signal blocks.

In a ninth aspect, the uplink grant is a first uplink grant, and process 800 includes changing from operating in a first orientation to operating in a second orientation, and repeating, using the second orientation, transmission of the one or more reference signals using the first polarization, transmission of the beam lock command, and transmission of a second uplink grant that is configured based at least in part on the EIRP conformance testing procedure and is assigned to the network node.

In a tenth aspect, changing from operating with the first orientation to operating with the second orientation includes changing at least one of an azimuth angle of the LEN, or an elevation angle of the LEN.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with an EIRP conformance testing procedure (e.g., an EIRP mask conformance testing procedure) for a network node using a link establishment node.

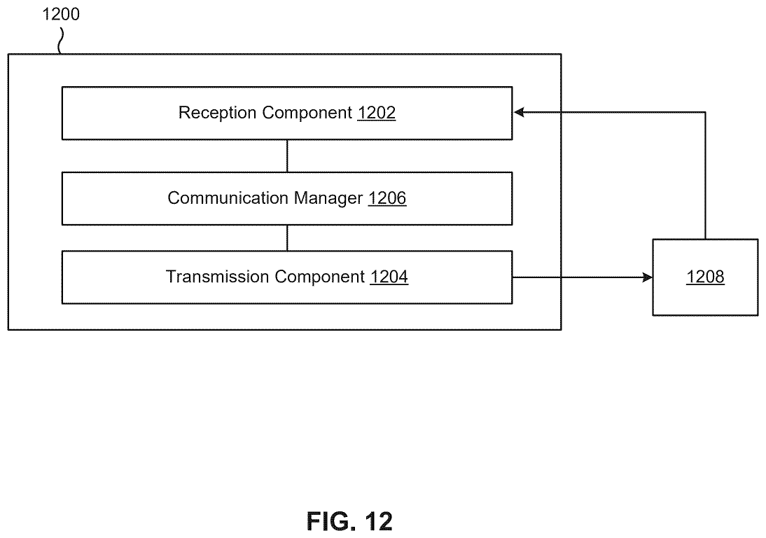

As shown in FIG. 9, in some aspects, process 900 may include receiving one or more reference signals that have a first polarization, the one or more reference signals being configured for an EIRP conformance testing procedure for the network node (block 910). In some aspects, the network node (e.g., using reception component 1202 and/or communication manager 1206, depicted in FIG. 12) may receive one or more reference signals that have a first polarization, the one or more reference signals being configured for an EIRP conformance testing procedure for the network node, as described above.

As further shown in FIG. 9, in some aspects, process 900 may include receiving a beam lock command that indicates to select a locked beam pair (block 920). In some aspects, the network node (e.g., using reception component 1202 and/or communication manager 1206, depicted in FIG. 12) may receive a beam lock command that indicates to select a locked beam pair, as described above.

As further shown in FIG. 9, in some aspects, process 900 may include receiving an uplink grant that is configured for the EIRP conformance testing procedure and is assigned to the network node (block 930). In some aspects, the network node (e.g., using reception component 1202 and/or communication manager 1206, depicted in FIG. 12) may receive an uplink grant that is configured for the EIRP conformance testing procedure and is assigned to the network node, as described above.

As further shown in FIG. 9, in some aspects, process 900 may include transmitting one or more transmissions using the locked beam pair (block 940). In some aspects, the network node (e.g., using transmission component 1204 and/or communication manager 1206, depicted in FIG. 12) may transmit one or more transmissions using the locked beam pair, as described above.

Process 900 may include additional aspects, such as any single aspect or any combination of aspects described below and/or in connection with one or more other processes described elsewhere herein.

In a first aspect, the EIRP conformance testing procedure is based at least in part on validating compliance with an EIRP mask by the network node.

In a second aspect, process 900 includes generating one or more measurement metrics using the one or more reference signals, and selecting, based at least in part on receiving the beam lock command, the locked beam pair using the one or more measurement metrics.

In a third aspect, selecting the locked beam pair includes selecting the locked beam pair using a beamforming codebook.

In a fourth aspect, selecting the beam pair includes receiving the one or more reference signals using one or more potential beam pairs, and selecting, as the locked beam pair, a particular potential beam pair from the one or more potential beam pairs that has a highest correlation to a directional link that is associated with the one or more reference signals.

In a fifth aspect, process 900 includes receiving a beam unlock command that is directed to the network node.

In a sixth aspect, the one or more reference signals are first one or more reference signals, the beam lock command is a first beam lock command, the uplink grant is a first uplink grant, the one or more transmissions are first one or more transmissions, and the locked beam pair is a first locked beam pair, and process 900 includes receiving second one or more reference signals that use a second polarization and are configured for the EIRP conformance testing procedure, receiving a second beam lock command that indicates to select a second locked beam pair, receiving a second uplink grant that is configured based at least in part on the EIRP conformance testing procedure and is assigned to the network node, and transmitting using a second locked beam pair second one or more transmissions that are based at least in part on the EIRP conformance testing procedure.

In a seventh aspect, the one or more reference signals include one or more synchronization signal blocks.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, In some aspects, at a test equipment or an apparatus of a test equipment, in accordance with the present disclosure. Example process 1000 is an example where the apparatus or the test equipment (e.g., test equipment 606 and/or apparatus 1300) performs operations associated with an EIRP conformance testing procedure (e.g., an EIRP mask conformance testing procedure) for a network node using a link establishment node.

As shown in FIG. 10, in some aspects, process 1000 may include receiving an indication to initiate a measurement cycle that is at least part of an EIRP conformance testing procedure for a network node generating, at a first orientation of the test equipment, first one or more measurement metrics (block 1010). In some aspects, the test equipment (e.g., using reception component 1302 and/or communication manager 1306, depicted in FIG. 13) may receive an indication to initiate a measurement cycle that is at least part of an EIRP conformance testing procedure for a network node generating, at a first orientation of the test equipment, first one or more measurement metrics, as described above.

As further shown in FIG. 10, in some aspects, process 1000 may include reconfiguring the test equipment to at least a second orientation (block 1020). In some aspects, the test equipment (e.g., using communication manager 1306, depicted in FIG. 13) may reconfigure the test equipment to at least a second orientation, as described above.

As further shown in FIG. 10, in some aspects, process 1000 may include generating, at the second orientation, second one or more measurement metrics (block 1030). In some aspects, the test equipment (e.g., using communication manager 1306, depicted in FIG. 12) may generate, at the second orientation, second one or more measurement metrics, as described above.

Process 1000 may include additional aspects, such as any single aspect or any combination of aspects described below and/or in connection with one or more other processes described elsewhere herein.

In a first aspect, the first orientation or the second orientation includes one or more of a location of the test equipment, or a rotation vector of the test equipment, the rotation vector that is characterized based at least in part on an axis of rotation, and an angle of rotation around the axis of rotation.

In a second aspect, the first one or more measurement metrics or the second one or more measurement metrics include a received signal power metric.

In a third aspect, generating the first one or more measurement metrics includes generating the first one or more measurement metrics using a first polarization and a second polarization.

In a fourth aspect, generating the second one or more measurement metrics includes generating the second one or more measurement metrics using a first polarization and a second polarization.

In a fifth aspect, process 1000 includes generating a compliance metric using at least the first one or more measurement metrics or the second one or more measurement metrics.

In a sixth aspect, the EIRP conformance testing procedure is based at least in part on verifying compliance with an EIRP mask.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a LEN, or a LEN may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as test equipment, a UE, or a network node (such as a CU, a DU, an RU, or a base station), using the reception component 1102 and the transmission component 1104.

In some aspects, the apparatus 1100 may be configured to perform one or more operations described herein in connection with FIGS. 4-7. Additionally, or alternatively, the apparatus 1100 may be configured to perform one or more processes described herein, such as process 800 of FIG. 8, or a combination thereof. In some aspects, the apparatus 1100 and/or one or more components shown in FIG. 11 may include one or more components of the LEN described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. In some aspects, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the LEN described in connection with FIG. 1 and FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the LEN described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. In some aspects, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, using a first polarization, one or more reference signals that are configured for an EIRP conformance testing procedure for a network node. The transmission component 1104 may transmit, based at least in part on expiration of a beam selection timer, a beam lock command that is directed to the network node. The transmission component 1104 may transmit, based at least in part on transmitting the beam lock command, an indication of an uplink grant that is configured for the EIRP conformance testing procedure and is assigned to the network node.

The reception component 1102 may receive, from the test equipment, an indication that indicates completion of the measurement cycle. Based at least in part on receiving the indication, the transmission component 1104 may transmit a beam unlock command that is directed to the network node.

The reception component 1102 may receive a duration configuration for a beam selection timer. In some aspects, the communication manager 1106 may configure the beam selection timer to expire based at least in part on the duration configuration.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-7. Additionally, or alternatively, the apparatus 1200 may be configured to perform one or more processes described herein, such as process 900 of FIG. 9, or a combination thereof. In some aspects, the apparatus 1200 and/or one or more components shown in FIG. 12 may include one or more components of the network node described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. In some aspects, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1204 may be co-located with the reception component 1202 in one or more transceivers.

The communication manager 1206 may support operations of the reception component 1202 and/or the transmission component 1204. In some aspects, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive one or more reference signals that have a first polarization, the one or more reference signals being configured for an EIRP conformance testing procedure for the network node. The reception component 1202 may receive a beam lock command that indicates to select a locked beam pair. The reception component 1202 may receive an uplink grant that is configured for the EIRP conformance testing procedure and is assigned to the network node. The transmission component 1204 may transmit one or more transmissions using the locked beam pair.

The communication manager 1206 may generate one or more measurement metrics using the one or more reference signals. Alternatively, or additionally, the communication manager 1206 may select, based at least in part on receiving the beam lock command, the locked beam pair using the one or more measurement metrics. In some aspects, the reception component 1202 may receive a beam unlock command that is directed to the network node.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a test equipment, or a test equipment may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 4-7. Additionally, or alternatively, the apparatus 1300 may be configured to perform one or more processes described herein, such as process 1000 of FIG. 10, or a combination thereof. In some aspects, the apparatus 1300 and/or one or more components shown in FIG. 13 may include one or more components of the test equipment described in connection with FIG. 1 and FIG. 2. Additionally, or alternatively, one or more components shown in FIG. 13 may be implemented within one or more components described in connection with FIG. 1 and FIG. 2. Additionally, or alternatively, one or more components of the set of components may be implemented at least in part as software stored in one or more memories. In some aspects, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the test equipment described in connection with FIG. 1 and FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the test equipment described in connection with FIG. 1 and FIG. 2. In some aspects, the transmission component 1304 may be co-located with the reception component 1302 in one or more transceivers.

The communication manager 1306 may support operations of the reception component 1302 and/or the transmission component 1304. In some aspects, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive an indication to initiate a measurement cycle that is at least part of an EIRP conformance testing procedure for a network node generating, at a first orientation of the test equipment, first one or more measurement metrics. The communication manager 1306 may reconfigure the test equipment to at least a second orientation. The communication manager 1306 may generate, at the second orientation, second one or more measurement metrics.

The communication manager 1306 may generate a compliance metric using at least the first one or more measurement metrics or the second one or more measurement metrics.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a link establishment node (LEN), comprising: transmitting, using a first polarization, one or more reference signals that are configured for an effective isotropic radiated power (EIRP) conformance testing procedure for a network node; transmitting, based at least in part on expiration of a beam selection timer, a beam lock command that is directed to the network node; and transmitting, based at least in part on transmitting the beam lock command, an indication of an uplink grant that is configured for the EIRP conformance testing procedure and is assigned to the network node.

Aspect 2: The method of Aspect 1, wherein the EIRP conformance testing procedure is based at least in part on validating compliance with an EIRP mask.

Aspect 3: The method of any of Aspects 1-2, wherein the uplink grant is configured for a measurement cycle that is at least part of the EIRP conformance testing procedure, and wherein the method further comprises: transmitting, based at least in part on completion of the measurement cycle, a beam unlock command that is directed to the network node.

Aspect 4: The method of any of Aspects 1-3, wherein the indication is a first indication, and wherein the method further comprises: transmitting a second indication to initiate a measurement cycle that is at least part of the EIRP conformance testing procedure, the second indication being directed to a test equipment.

Aspect 5: The method of Aspect 4, further comprising: receiving, from the test equipment, a third indication that indicates completion of the measurement cycle; and transmitting, based at least in part on receiving the third indication, a beam unlock command that is directed to the network node.

Aspect 6: The method of any of Aspects 1-5, further comprising: receiving a duration configuration for the beam selection timer; and configuring the beam selection timer to expire based at least in part on the duration configuration.

Aspect 7: The method of any of Aspects 1-6, wherein transmitting the one or more reference signals using the first polarization comprises: transmitting the one or more reference signals for a duration that is indicated by the beam selection timer.

Aspect 8: The method of any of Aspects 1-7, wherein the one or more reference signals are first one or more reference signals, the beam selection timer is a first beam selection timer, the beam lock command is a first beam lock command, and the indication of the uplink grant is a first indication of a first uplink grant, and wherein the method further comprises: transmitting, using a second polarization, second one or more reference signals that are configured based at least in part on the EIRP conformance testing procedure for the network node; transmitting, based at least in part on expiration of a second beam selection timer, a second beam lock command that is directed to the network node; and transmitting a second indication of a second uplink grant that is configured based at least in part on the EIRP conformance testing procedure and is assigned to the network node.

Aspect 9: The method of any of Aspects 1-8, wherein the one or more reference signals include one or more synchronization signal blocks.

Aspect 10: The method of any of Aspects 1-9, wherein the uplink grant is a first uplink grant, and wherein the method further comprises: changing from operating in a first orientation to operating in a second orientation; and repeating, using the second orientation, transmission of the one or more reference signals using the first polarization, transmission of the beam lock command, and transmission of a second uplink grant that is configured based at least in part on the EIRP conformance testing procedure and is assigned to the network node.

Aspect 11: The method of Aspect 10, wherein changing from operating with the first orientation to operating with the second orientation comprises changing at least one of: an azimuth angle of the LEN, or an elevation angle of the LEN.

Aspect 12: A method of wireless communication performed by a network node, comprising: receiving one or more reference signals that have a first polarization, the one or more reference signals being configured for an effective isotropic radiated power (EIRP) conformance testing procedure for the network node; receiving a beam lock command that indicates to select a locked beam pair; receiving an uplink grant that is configured for the EIRP conformance testing procedure and is assigned to the network node; and transmitting one or more transmissions using the locked beam pair.

Aspect 13: The method of Aspect 12, wherein the EIRP conformance testing procedure is based at least in part on validating compliance with an EIRP mask by the network node.

Aspect 14: The method of any of Aspects 12-13, further comprising: generating one or more measurement metrics using the one or more reference signals; and selecting, based at least in part on receiving the beam lock command, the locked beam pair using the one or more measurement metrics.

Aspect 15: The method of Aspect 14, wherein selecting the locked beam pair further comprises: selecting the locked beam pair using a beamforming codebook.

Aspect 16: The method of Aspect 14 or Aspect 15, wherein selecting the beam pair further comprises: receiving the one or more reference signals using one or more potential beam pairs; and selecting, as the locked beam pair, a particular potential beam pair from the one or more potential beam pairs that has a highest correlation to a directional link that is associated with the one or more reference signals.

Aspect 17: The method of any of Aspects 12-16, further comprising: receiving a beam unlock command that is directed to the network node.

Aspect 18: The method of any of Aspects 12-17, wherein the one or more reference signals are first one or more reference signals, the beam lock command is a first beam lock command, the uplink grant is a first uplink grant, the one or more transmissions are first one or more transmissions, and the locked beam pair is a first locked beam pair, and wherein the method further comprises: receiving second one or more reference signals that use a second polarization and are configured for the EIRP conformance testing procedure; receiving a second beam lock command that indicates to select a second locked beam pair; receiving a second uplink grant that is configured based at least in part on the EIRP conformance testing procedure and is assigned to the network node; and transmitting using a second locked beam pair second one or more transmissions that are based at least in part on the EIRP conformance testing procedure.

Aspect 19: The method of any of Aspects 12-18, wherein the one or more reference signals include one or more synchronization signal blocks.

Aspect 20: A method of wireless communication performed by a test equipment, comprising: receiving an indication to initiate a measurement cycle that is at least part of an effective isotropic radiated power (EIRP) conformance testing procedure for a network node generating, at a first orientation of the test equipment, first one or more measurement metrics; reconfiguring the test equipment to at least a second orientation; and generating, at the second orientation, second one or more measurement metrics.

Aspect 21: The method of Aspect 20, wherein the first orientation or the second orientation comprises one or more of: a location of the test equipment, or a rotation vector of the test equipment, the rotation vector that is characterized based at least in part on: an axis of rotation, and an angle of rotation around the axis of rotation.

Aspect 22: The method of any of Aspects 20-21, wherein the first one or more measurement metrics or the second one or more measurement metrics include a received signal power metric.

Aspect 23: The method of any of Aspects 20-22, wherein generating the first one or more measurement metrics comprises: generating the first one or more measurement metrics using a first polarization and a second polarization.

Aspect 24: The method of any of Aspects 20-23, wherein generating the second one or more measurement metrics comprises: generating the second one or more measurement metrics using a first polarization and a second polarization.

Aspect 25: The method of any of Aspects 20-24, further comprising: generating a compliance metric using at least the first one or more measurement metrics or the second one or more measurement metrics.

Aspect 26: The method of Aspect 25, wherein the EIRP conformance testing procedure is based at least in part on verifying compliance with an EIRP mask.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-11.

Aspect 28: An apparatus for wireless communication at a device, the apparatus comprising one or more memories and one or more processors coupled to the one or more memories, the one or more processors configured to cause the device to perform the method of one or more of Aspects 1-11.

Aspect 29: An apparatus for wireless communication, the apparatus comprising at least one means for performing the method of one or more of Aspects 1-11.

Aspect 30: A non-transitory computer-readable medium storing code for wireless communication, the code comprising instructions executable by one or more processors to perform the method of one or more of Aspects 1-11.

Aspect 31: A non-transitory computer-readable medium storing a set of instructions for wireless communication, the set of instructions comprising one or more instructions that, when executed by one or more processors of a device, cause the device to perform the method of one or more of Aspects 1-11.

Aspect 32: A device for wireless communication, the device comprising a processing system that includes one or more processors and one or more memories coupled with the one or more processors, the processing system configured to cause the device to perform the method of one or more of Aspects 1-11.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-11.

Aspect 34: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 12-19.

Aspect 35: An apparatus for wireless communication at a device, the apparatus comprising one or more memories and one or more processors coupled to the one or more memories, the one or more processors configured to cause the device to perform the method of one or more of Aspects 12-19.

Aspect 36: An apparatus for wireless communication, the apparatus comprising at least one means for performing the method of one or more of Aspects 12-19.

Aspect 37: A non-transitory computer-readable medium storing code for wireless communication, the code comprising instructions executable by one or more processors to perform the method of one or more of Aspects 12-19.

Aspect 38: A non-transitory computer-readable medium storing a set of instructions for wireless communication, the set of instructions comprising one or more instructions that, when executed by one or more processors of a device, cause the device to perform the method of one or more of Aspects 12-19.

Aspect 39: A device for wireless communication, the device comprising a processing system that includes one or more processors and one or more memories coupled with the one or more processors, the processing system configured to cause the device to perform the method of one or more of Aspects 12-19.

Aspect 40: An apparatus for wireless communication at a device, the apparatus comprising one or more memories and one or more processors coupled to the one or more memories, the one or more processors individually or collectively configured to cause the device to perform the method of one or more of Aspects 12-19.

Aspect 41: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 20-26.

Aspect 42: An apparatus for wireless communication at a device, the apparatus comprising one or more memories and one or more processors coupled to the one or more memories, the one or more processors configured to cause the device to perform the method of one or more of Aspects 20-26.

Aspect 43: An apparatus for wireless communication, the apparatus comprising at least one means for performing the method of one or more of Aspects 20-26.

Aspect 44: A non-transitory computer-readable medium storing code for wireless communication, the code comprising instructions executable by one or more processors to perform the method of one or more of Aspects 20-26.

Aspect 45: A non-transitory computer-readable medium storing a set of instructions for wireless communication, the set of instructions comprising one or more instructions that, when executed by one or more processors of a device, cause the device to perform the method of one or more of Aspects 20-26.

Aspect 46: A device for wireless communication, the device comprising a processing system that includes one or more processors and one or more memories coupled with the one or more processors, the processing system configured to cause the device to perform the method of one or more of Aspects 20-26.

Aspect 47: An apparatus for wireless communication at a device, the apparatus comprising one or more memories and one or more processors coupled to the one or more memories, the one or more processors individually or collectively configured to cause the device to perform the method of one or more of Aspects 20-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a link establishment node (LEN), comprising:
one or more memories; and
one or more processors, coupled to the one or more memories, configured individually or collectively to cause the LEN to:
transmit, using a first polarization, one or more reference signals that are configured for an effective isotropic radiated power (EIRP) conformance testing procedure for a network node;
transmit, based at least in part on expiration of a beam selection timer, a beam lock command that is directed to the network node; and
transmit, based at least in part on transmitting the beam lock command, an indication of an uplink grant that is configured for the EIRP conformance testing procedure and is assigned to the network node.

2. The apparatus of claim 1, wherein the EIRP conformance testing procedure is based at least in part on validating compliance with an EIRP mask.

3. The apparatus of claim 1, wherein the uplink grant is configured for a measurement cycle that is at least part of the EIRP conformance testing procedure, and
wherein the one or more processors are further configured, individually or collectively, to cause the LEN to:
transmit, based at least in part on completion of the measurement cycle, a beam unlock command that is directed to the network node.

4. The apparatus of claim 1, wherein the indication is a first indication, and
wherein the one or more processors are further configured, individually or collectively, to cause the LEN to:
transmit a second indication to initiate a measurement cycle that is at least part of the EIRP conformance testing procedure, the second indication being directed to a test equipment.

5. The apparatus of claim 1, wherein the one or more processors are further configured, individually or collectively, to cause the LEN to:
receive a duration configuration for the beam selection timer; and
configure the beam selection timer to expire based at least in part on the duration configuration.

6. The apparatus of claim 1, wherein the one or more processors, to cause the LEN to transmit the one or more reference signals using the first polarization, are configured, individually or collectively, to cause the LEN to:
transmit the one or more reference signals for a duration that is indicated by the beam selection timer.

7. The apparatus of claim 1, wherein the one or more reference signals are first one or more reference signals, the beam selection timer is a first beam selection timer, the beam lock command is a first beam lock command, and the indication of the uplink grant is a first indication of a first uplink grant, and
wherein the one or more processors are further configured, individually or collectively, to cause the LEN to:
transmit, using a second polarization, second one or more reference signals that are configured based at least in part on the EIRP conformance testing procedure for the network node;
transmit, based at least in part on expiration of a second beam selection timer, a second beam lock command that is directed to the network node; and
transmit a second indication of a second uplink grant that is configured based at least in part on the EIRP conformance testing procedure and is assigned to the network node.

8. The apparatus of claim 1, wherein the one or more reference signals include one or more synchronization signal blocks.

9. The apparatus of claim 1, wherein the uplink grant is a first uplink grant, and
wherein the one or more processors are further configured, individually or collectively, to cause the LEN to:
change from operating in a first orientation to operating in a second orientation; and
repeat, using the second orientation, transmission of the one or more reference signals using the first polarization, transmission of the beam lock command, and transmission of a second uplink grant that is configured based at least in part on the EIRP conformance testing procedure and is assigned to the network node.

10. A method of wireless communication performed by a link establishment node (LEN), comprising:
transmitting, using a first polarization, one or more reference signals that are configured for an effective isotropic radiated power (EIRP) conformance testing procedure for a network node;
transmitting, based at least in part on expiration of a beam selection timer, a beam lock command that is directed to the network node; and
transmitting, based at least in part on transmitting the beam lock command, an indication of an uplink grant that is configured for the EIRP conformance testing procedure and is assigned to the network node.

11. The method of claim 10, wherein the EIRP conformance testing procedure is based at least in part on validating compliance with an EIRP mask.

12. The method of claim 10, wherein the uplink grant is configured for a measurement cycle that is at least part of the EIRP conformance testing procedure, and
wherein the method further comprises:
transmitting, based at least in part on completion of the measurement cycle, a beam unlock command that is directed to the network node.

13. The method of claim 10, wherein transmitting the one or more reference signals using the first polarization comprises:
transmitting the one or more reference signals for a duration that is indicated by the beam selection timer.

14. The method of claim 10, wherein the one or more reference signals are first one or more reference signals, the beam selection timer is a first beam selection timer, the beam lock command is a first beam lock command, and the indication of the uplink grant is a first indication of a first uplink grant, and
wherein the method further comprises:
transmitting, using a second polarization, second one or more reference signals that are configured based at least in part on the EIRP conformance testing procedure for the network node;
transmitting, based at least in part on expiration of a second beam selection timer, a second beam lock command that is directed to the network node; and
transmitting a second indication of a second uplink grant that is configured based at least in part on the EIRP conformance testing procedure and is assigned to the network node.

15. The method of claim 10, wherein the uplink grant is a first uplink grant, and
wherein the method further comprises:
changing from operating in a first orientation to operating in a second orientation; and
repeating, using the second orientation, transmission of the one or more reference signals using the first polarization, transmission of the beam lock command, and transmission of a second uplink grant that is configured based at least in part on the EIRP conformance testing procedure and is assigned to the network node.

16. A non-transitory computer-readable medium storing a set of instructions for wireless communication, the set of instructions comprising:
one or more instructions that, when executed by one or more processors of a link establishment node (LEN), cause the LEN to:
transmit, using a first polarization, one or more reference signals that are configured for an effective isotropic radiated power (EIRP) conformance testing procedure for a network node;
transmit, based at least in part on expiration of a beam selection timer, a beam lock command that is directed to the network node; and
transmit, based at least in part on transmitting the beam lock command, an indication of an uplink grant that is configured for the EIRP conformance testing procedure and is assigned to the network node.

17. The non-transitory computer-readable medium of claim 16, wherein the EIRP conformance testing procedure is based at least in part on validating compliance with an EIRP mask.

18. The non-transitory computer-readable medium of claim 16, wherein the uplink grant is configured for a measurement cycle that is at least part of the EIRP conformance testing procedure, and
wherein the one or more instructions further cause the LEN to:
transmit, based at least in part on completion of the measurement cycle, a beam unlock command that is directed to the network node.

19. The non-transitory computer-readable medium of claim 16, wherein the indication is a first indication, and
wherein the one or more instructions further cause the LEN to:
transmit a second indication to initiate a measurement cycle that is at least part of the EIRP conformance testing procedure, the second indication being directed to a test equipment.

20. The non-transitory computer-readable medium of claim 16, wherein the uplink grant is a first uplink grant, and
wherein the one or more instructions further cause the LEN to:
change from operating in a first orientation to operating in a second orientation; and
repeat, using the second orientation, transmission of the one or more reference signals using the first polarization, transmission of the beam lock command, and transmission of a second uplink grant that is configured based at least in part on the EIRP conformance testing procedure and is assigned to the network node.
